(19) United States
(12) Patent Application Publication
(10) Pub. No.: US 2026/0129211 A1
(43) Pub. Date: May 7, 2026

(54) VIDEO SIGNAL PROCESSING METHOD USING LUMINANCE SAMPLE-BASED CHROMINANCE SAMPLE PREDICTION AND APPARATUS THEREFOR

(71) Applicant: WILUS INSTITUTE OF STANDARDS AND TECHNOLOGY INC., Gyeonggi-do (KR)

(72) Inventors: Kyungyong KIM, Gyeonggi-do (KR); Dongcheol KIM, Gyeonggi-do (KR); Juhyung SON, Gyeonggi-do (KR); Jinsam KWAK, Gyeonggi-do (KR)

(21) Appl. No.: 19/119,104

(22) PCT Filed: Oct. 23, 2023
(86) PCT No.: PCT/KR2023/016463

§ 371 Date: Apr. 8, 2025

(30) Foreign Application Priority Data
Oct. 26, 2022 (KR) 10-2022-0139744
Apr. 14, 2023 (KR) 10-2023-0049596
Apr. 19, 2023 (KR) 10-2023-0051599

(51) Int. Cl. H04N 19/149; H04N 19/176; H04N 19/186

(52) U.S. Cl. CPC H04N 19/149; H04N 19/176; H04N 19/186

(57) ABSTRACT

A video signal decoding apparatus is disclosed. The decoding apparatus comprises a processor. The processor: acquires a model that models the relationship between a value of a luma sample of the current block and a value of a chroma sample of the current block, on the basis of a value of at least one sample from among a neighboring luma sample of the current block, a chroma sample corresponding to the neighboring luma sample of the current block, a neighboring luma sample of a reference block, and a chroma sample corresponding to the neighboring luma sample of the reference block; and predicts a chroma block of the current block by using the acquired model and a luma block of the current block.

### TECHNICAL FIELD

The disclosure relates to a method and an apparatus device for processing a video signal and, more particularly, to a video signal processing method and apparatus for encoding or decoding a video signal.

### BACKGROUND ART

Compression encoding refers to a series of signal processing technologies for transmitting digitized information through a communication line or storing this information in a storage medium in an appropriate form. Examples of targets of compression encoding are voice, images, text, etc., and particularly, a technology for performing compression encoding of an image is called video image compression. Compression encoding of a video signal is performed by removing surplus information in consideration of spatial correlation, temporal correlation, probabilistic correlation, etc. However, recently, as various media and data transmission media have been developed, there is an increasing need for a highly efficient method and apparatus for processing a video signal.

### DISCLOSURE OF INVENTION

### Technical Problem

This specification is to increase the coding efficiency of a video signal by providing a video signal processing method and an apparatus for the same.

### Solution to Problem

A video signal decoding apparatus according to an embodiment of the disclosure includes a processor. The processor acquires a model that models a relationship between a value of a luma sample of a current block and a value of a chroma sample of the current block, based on a value of at least one sample from among a neighboring luma sample of the current block, a chroma sample corresponding to the neighboring luma sample of the current block, a neighboring luma sample of a reference block, and a chroma sample corresponding to the neighboring luma sample of the reference block, and predicts a chroma block of the current block by using the acquired model and a luma block of the current block.

The processor may generate a chroma prediction block by using the acquired model and the luma block of the current block, and reconstruct the chroma block of the current block by adding an error block to the chroma prediction block.

When the decoding apparatus acquires the model, the processor may acquire a first model and a second model, generate a first chroma prediction sample by using the luma sample of the current block and the first model, generate a second chroma prediction sample by using the luma sample of the current block and the second model, generate a third chroma prediction sample by performing weighted averaging of the first chroma prediction sample and the second chroma prediction sample, generate a chroma prediction block by using the third chroma prediction sample, and reconstruct the chroma block of the current block by adding the error block to the chroma prediction block.

When the current block is coded in an inter-coding mode and is applied with bi-directional prediction, the processor may derive the first model by using a first prediction block predicted using L0 motion information and derive the second model by using a second prediction block predicted using L1 motion information.

An input value input to the model may include a value obtained by subtracting a predesignated first offset value from the value of the luma sample of the current block, a value obtained by subtracting a predesignated second offset value from the value of a Cb chroma sample of the current block, and a value obtained by subtracting a predesignated third offset value from the value of a Cr chroma sample of the current block.

The predesignated first offset value may be a value of a luma sample at a predesignated position among the neighboring samples of the current block, the predesignated second offset value is a value of a Cb chroma sample at the predesignated position, and the predesignated third offset value is a value of a Cr chroma sample at the predesignated position.

When the value of the luma sample at the predesignated position does not fall within a predesignated range, the processor may use a predesignated basic first offset value as the first offset value, a predesignated basic second offset value as the second offset value, and a predesignated basic third offset value as the third offset value.

When the value of the luma sample at the predesignated position does not fall within a predesignated range, the processor may determine that the chroma block of the current block is unable to use an coding mode based on the model, and may omit to parse at least one syntax element related to the model.

When the value of the luma sample at the predesignated position does not fall within a predesignated range, the processor may determine in a predesignated order whether values of luma samples at a plurality of predesignated positions are valid as the first offset value, and when a luma sample value valid as the first offset value is discovered, the processor may use the discovered luma sample value as the first offset value, the value of the Cb chroma sample corresponding to the discovered luma sample value as the second offset value, and the value of the Cr chroma sample corresponding to the discovered luma sample as the third offset value.

The processor may parse offset sample information indicating an offset sample from a bitstream including the video signal, and may use the value of the luma sample indicated by the offset sample information as the first offset value, use the value of the Cb chroma sample indicated by the offset sample information as the second offset value, and use the value of the Cr chroma sample indicated by the offset sample information as the third offset value.

According to another embodiment of the disclosure, a decoding apparatus that decodes a video signal includes a processor. The processor acquires motion information for a current block, generates a luma prediction block and a first chroma prediction block for the current block by using the motion information, acquires a model for modeling the relationship between the luma prediction block and the first chroma prediction block, generates a reconstructed luma block for the current block by adding a luma error block to the luma prediction block, predicts a second chroma block of the current block, based on the acquired model and the reconstructed luma block, generates a third chroma prediction block by performing weighted averaging of the first chroma block of the current block and the second chroma block of the current block, and reconstructs the chroma block of the current block by adding a chroma error block to the third chroma block.

The processor may predict the second chroma block of the current block by using the acquired model and the reconstructed luma block.

The processor may predict a second chroma sample of the current block by using the acquired model and the reconstructed luma sample of the reconstructed luma block.

The acquired model may be derived using at least one of a vertical difference and a horizontal difference between the luma prediction sample and a plurality of luma samples around the luma prediction sample, and the vertical and horizontal coordinates of the luma prediction sample.

The acquired model may be derived without downsampling the luma prediction sample.

The processor may predict the second chroma sample of the current block by using at least one of a reconstructed luma sample of the reconstructed luma block, a vertical difference and a horizontal difference between the reconstructed luma sample and a plurality of luma samples around the reconstructed luma sample, and the vertical and horizontal coordinates of the reconstructed luma sample.

The processor may predict a second chroma sample of the current block without downsampling the reconstructed luma sample for the current block.

The processor may apply a first weight to the first chroma sample and a second weight to the second chroma sample. Here, the second weight may be greater than the first weight.

An encoding apparatus for encoding a video signal according to an embodiment of the disclosure includes a processor. The processor acquires a model that models the relationship between the value of the luma sample of the current block and the value of the chroma sample of the current block, based on a value of at least one sample from among a neighboring luma sample of a current block, a chroma sample corresponding to the neighboring luma sample of the current block, a neighboring luma sample of a reference block, and a chroma sample corresponding to the neighboring luma sample of the reference block, and predicts the chroma block of the current block by using the acquired model and the luma block of the current block.

According to another embodiment of the disclosure, an encoding apparatus for encoding a video signal includes a processor. The processor acquires motion information for a current block, generates a luma prediction block and a first chroma prediction block for the current block by using the motion information, acquires a model for modeling the relationship between the luma prediction block and the first chroma prediction block, generates a reconstructed luma block for the current block by adding a luma error block to the luma prediction block, predicts a second chroma block of the current block, based on the acquired model and the reconstructed luma block, generates a third chroma prediction block by performing weighted averaging of the first chroma block of the current block and the second chroma block of the current block, and reconstructs the chroma block of the current block by adding a chroma error block to the third chroma block. According to an embodiment of the disclosure, a decoding method for decoding a video signal may include acquiring a model that models the relationship between a value of a luma sample of a current block and a value of a chroma sample of the current block, based on a value of at least one sample from among a neighboring luma sample of the current block, a chroma sample corresponding to the neighboring luma sample of the current block, a neighboring luma sample of a reference block, and a chroma sample corresponding to the neighboring luma sample of the reference block, and predicting a chroma block of the current block by using the acquired model and a luma block of the current block.

According to another embodiment of the disclosure, a decoding method for decoding a video signal may include acquiring motion information for a current block, generating a luma prediction block and a first chroma prediction block for the current block by using the motion information, acquiring a model that models the relationship between the luma prediction block and the first chroma prediction block; generating a reconstructed luma block for the current block by adding a luma error block to the luma prediction block, predicting a second chroma block of the current block, based on the acquired model and the reconstructed luma block, generating a third chroma prediction block by performing weighted averaging of the first chroma block of the current block and the second chroma block of the current block, and reconstructing the chroma block of the current block by adding a chroma error block to the third chroma block.

According to an embodiment of the disclosure, a non-transitory computer-readable storage medium storing a bitstream is disclosed. The bitstream is decoded using a decoding method. The decoding method includes acquiring, based on a value of at least one sample from among a neighboring luma sample of a current block, a chroma sample corresponding to the neighboring luma sample of the current block, a neighboring luma sample of a reference block, and a chroma sample corresponding to the neighboring luma sample of the reference block, a model that models the relationship between the value of the luma sample of the current block and the value of the chroma sample of the current block, and predicting the chroma block of the current block by using the acquired model and the luma block of the current block.

According to another embodiment of the disclosure, a non-transitory computer-readable storage medium storing a bitstream is disclosed. The bitstream is decoded using a decoding method. The decoding method includes acquiring motion information for a current block, generating a luma prediction block and a first chroma prediction block for the current block by using the motion information, acquiring a model that models the relationship between the luma prediction block and the first chroma prediction block, generating a reconstructed luma block for the current block by adding a luma error block to the luma prediction block, predicting a second chroma block of the current block, based on the acquired model and the reconstructed luma block,

Generating a third chroma prediction block by performing weighted averaging of the first chroma block of the current block and the second chroma block of the current block, and reconstructing the chroma block of the current block by adding a chroma error block to the third chroma block.

### Advantageous Effects of Invention

This specification provides a method for efficiently processing video signals. The effects that may be acquired in this specification are not limited to the effects mentioned above, and other effects not mentioned may be clearly understood by a person skilled in the art from the description below.

### BRIEF DESCRIPTION OF DRAWINGS

FIG. 1 is a schematic block diagram of a video signal encoding apparatus according to an embodiment of the disclosure;

FIG. 2 is a schematic block diagram of a video signal decoding apparatus according to an embodiment of the disclosure;

FIG. 3 illustrates an embodiment in which a coding tree unit is divided into coding units within a picture;

FIG. 4 illustrates an embodiment of a method for signaling splitting of quad trees and multi-type trees;

FIGS. 5 and 6 illustrate an intra-prediction method according to an embodiment of the disclosure in more detail;

FIG. 7 illustrates the positions of neighboring blocks used to generate a motion candidate list in inter-prediction;

FIG. 8 illustrates a block diagram in which CCLM is performed according to an embodiment of the disclosure;

FIG. 9 illustrates an example of a template configuration used to derive a linear model according to an embodiment of the disclosure;

FIG. 10 illustrates that an encoder and a decoder according to an embodiment of the disclosure derive two linear models, based on a threshold;

FIG. 11 illustrates a method of configuring syntax for a coding mode of a linear model according to an embodiment of the disclosure;

FIG. 12 illustrates probability initialization information for a mmlm_flag context model according to an embodiment of the disclosure;

FIG. 13 illustrates probability initialization information for a mmlm_flag context model according to an embodiment of the disclosure;

FIG. 14 illustrates a scheme of deriving an intra-prediction mode for the current block by using motion information of a neighboring block according to an embodiment of the disclosure;

FIG. 15 illustrates a method for predicting a chroma block by using a recursive linear model according to an embodiment of the disclosure;

FIG. 16 illustrates a reference area used to generate a reference linear model according to an embodiment of the disclosure;

FIG. 17 illustrates reference samples and a mathematical expression used in the CCCM according to an embodiment of the disclosure;

FIG. 18 illustrates a differential sample-based CCCM method according to an embodiment of the disclosure;

FIG. 19 illustrates a predesignated number of neighboring luma samples around the current block that are considered for derivation of a model used for chroma sample prediction according to an embodiment of the disclosure;

FIG. 20 illustrates luma samples before downsampling used to derive chroma samples in a CCCM-ND mode according to an embodiment of the disclosure;

FIG. 21 illustrates luma samples before downsampling used to derive chroma samples in a CCCM-ND mode according to an embodiment of the disclosure;

FIG. 22 illustrates a block diagram of a cross-component residual model (CCRM) according to an embodiment of the disclosure;

FIG. 23 illustrates a block diagram of a cross-component residual model (CCRM) according to an embodiment of the disclosure; and

FIG. 24 illustrates that CCRM is performed using the correlation between a luma prediction block and a luma reconstruction block according to an embodiment of the disclosure.

### MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luma”, “Y”, and the like may be used interchangeably in this specification. Additionally, in the present specification, the terms “chroma”, “chroma”, “Cb or Cr”, and the like may be used interchangeably, and chroma components are classified into two components, Cb and Cr, and thus each chroma component may be distinguished and used. Additionally, in this specification, the term “sample” refers to a fundamental element that constitutes a picture or frame. When the value of a luma sample is represented using 8 bits, it can range from 0 to 255, and when represented using 12 bits, it can range from 0 to 4095. The terms “sample,” “pixel,” and “picture element” may be used interchangeably. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

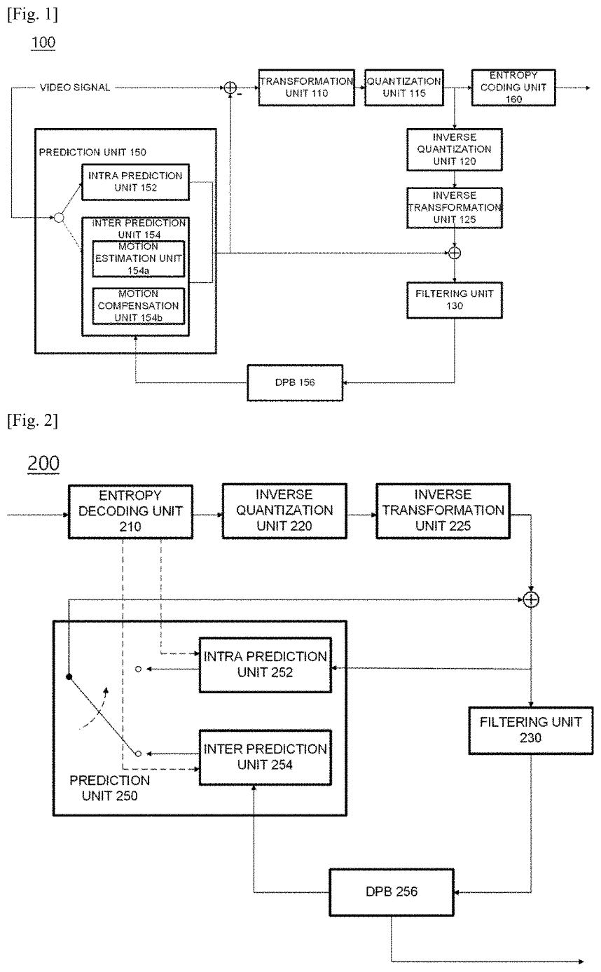

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract intra encoding information, inter encoding transform coefficient information, information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 reconstructs a residual value by using the inverse-quantized transform coefficient. The video signal processing device 200 reconstructs an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual value outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A subpicture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

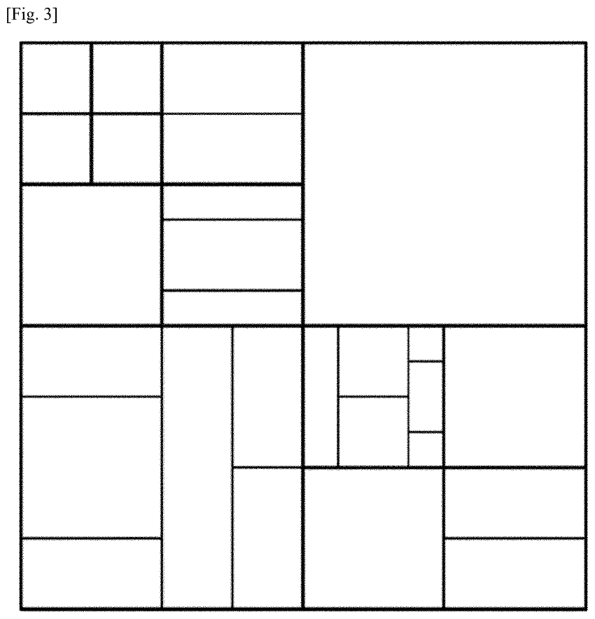

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

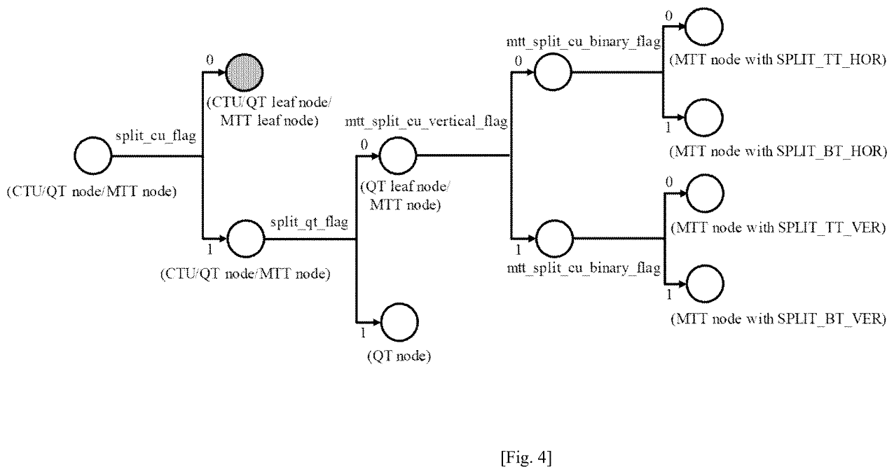

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad trcc or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra coding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

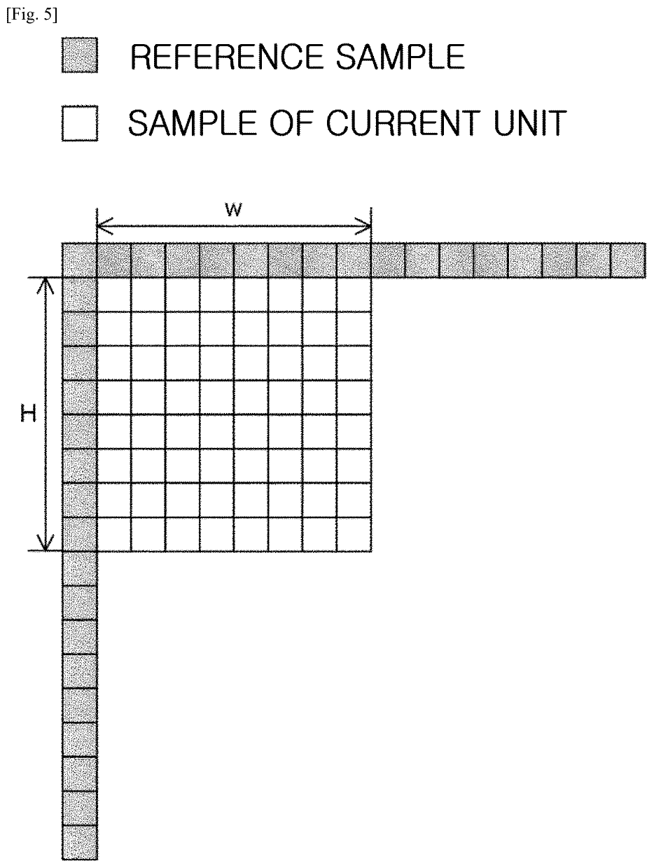

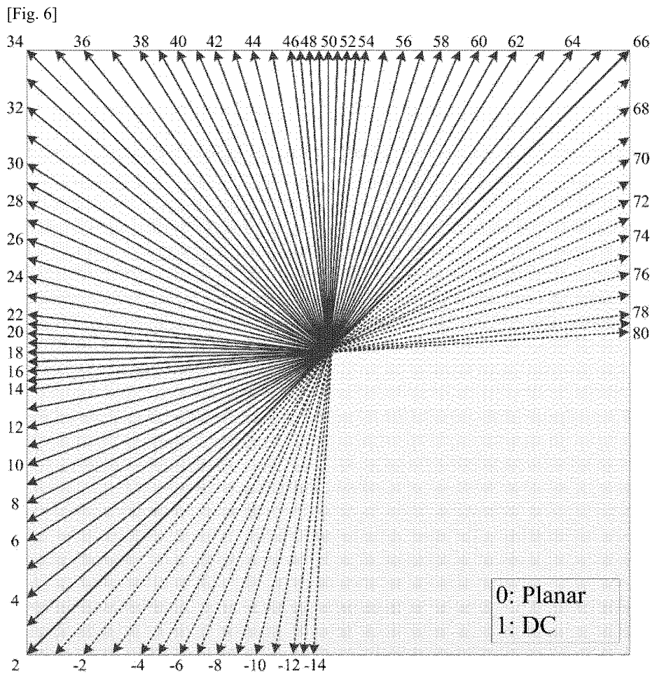

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is W×H and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been reconstructed, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than −135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_10, ref_idx_11), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L0 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different when applying the weighted average, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most optimal motion candidate indexes (mvp_10_flag, mvp_11_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

The motion candidate and the motion information candidate of this specification may have the same meaning. In addition, the motion candidate list and the motion information candidate list of this specification may have the same meaning.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already reconstructed reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM). In addition, like the CCLM and MMLM, a prediction method using correlations between different signals may be called cross-component prediction (CCP). The CCLM uses one linear model, and thus it may be called a single CCP model, and the MMLM uses multiple linear models, and thus it may be called a multi (or complex) CCP model.

The encoder and decoder may construct a reconstructed luma block by adding the luma prediction block of the current block and the error signal for the luma block, and then construct a CCP model by using the correlation between the reconstructed luma block and the luma prediction block. Here, the CCP model may be one of CCLM, MMLM, GLM, CCCM, MM-CCCM, GL-CCCM, CCCM-ND, and CCCM-MDF. The CCP model derived from the luma block may be applied to the chroma prediction block to generate a first chroma prediction block to which the CCP model is applied. A final chroma block may be generated by adding the error signal for the chroma block and the first chroma prediction block.

In addition, the CCP model is understood as meaning that at least one type of CCP model among the types of the CCP model is used. The CCP model may be configured by at least one CCP model. One CCP model may be configured by two CCLMs, and this may be referred to as MMLM. A new CCP model may be a different type of CCP model, or a model with the same type of CCP model but different parameter values. When the types of CCP models are different between CCP models, they may be called different CCP models. When the type of CCP model is the same between CCP models, but the parameters between CCP models are different, they may be called different CCP models. When the number of CCP models is different between CCP models (for example, when the first CCP model is configured by one CCLM and the second CCP model is configured by two CCLMs), they may be called different CCP models. The CCP model may include at least one of type information of the CCP model, parameter information of the CCP model, information on whether a multi-CCP such as MMLM or MM-CCCM were used, information on the average value of the luma block, and down-sampling filter information.

Convolutional cross-component model (CCCM) is a method of constructing a non-linear model by using the correlation between a luma signal and a chroma signal located at the same position as the luma signal, and then predicting the chroma signal by using the non-linear model.

Gradient linear model (GLM) is a method of constructing a model by additionally reflecting the gradient of the luma sample to a linear model such as CCLM, and then predicting the chroma signal by using the model.

Multi-model CCCM (MM-CCCM) is a method of deriving two CCCM parameters based on an average value of a reference area (or a reconstructed current luma block).

Gradient and location based convolutional cross-component model (GL-CCCM) is an additional CCCM mode using gradient and location information. The existing CCCM mode may derive a chroma sample for the current block by using a luma sample at the position corresponding to the chroma sample to be predicted, four samples around the luma sample, and coefficient information. Here, the GL-CCCM mode may derive a chroma sample for the current block by using the luma sample at the position corresponding to the chroma sample to be predicted, the vertical and horizontal differences for the 8 samples around the luma sample, the horizontal and vertical coordinates of the current luma sample, and the coefficient information of the prediction model.

In CCCM, which predicts the chroma block based on the luma block, it is necessary to lower the resolution of the luma block to that of the chroma block in order to match the resolution difference between the luma block and the chroma block. Here, various down-sampling filters may be applied. This mode may be referred to as CCCM with multiple down-sampling filters (CCCM-MDF).

In independent scalar quantization, a reconstructed coefficient t′k for an input coefficient tk depends only on a related quantization index qk. That is, a quantization index for a random reconstructed coefficient has a different value from quantization indexes for other reconstructed coefficients. Here, t′k may be a value that includes a quantization error in tk, and may be different or the same depending on quantization parameters. Here, t′k may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

A block predicted by using the intra prediction directional mode may have discontinuous edges at the above and left boundaries of the block. For example, if the current block is predicted by using vertical direction mode, discontinuous edges may exist at the left boundary of the block. To mitigate this discontinuity, the encoder and decoder may apply filtering to the samples at the boundary inside the prediction block. The filtering may determine whether to apply the filtering and/or the filtering weight by using at least one of a reconstructed sample adjacent to the current prediction block, location information of the reconstructed sample adjacent to the current prediction block, a sample at a boundary inside the current prediction block, location information of the sample at a boundary inside the current prediction block, the intra prediction directional mode of the current prediction block, and the horizontal size and the vertical size of the current prediction block. The filtering weight refer to the weight for a sample at a boundary inside the current prediction block and the weight for a reconstructed sample adjacent to the current prediction block. This filtering method may be referred to as position dependent prediction combination (PDPC).

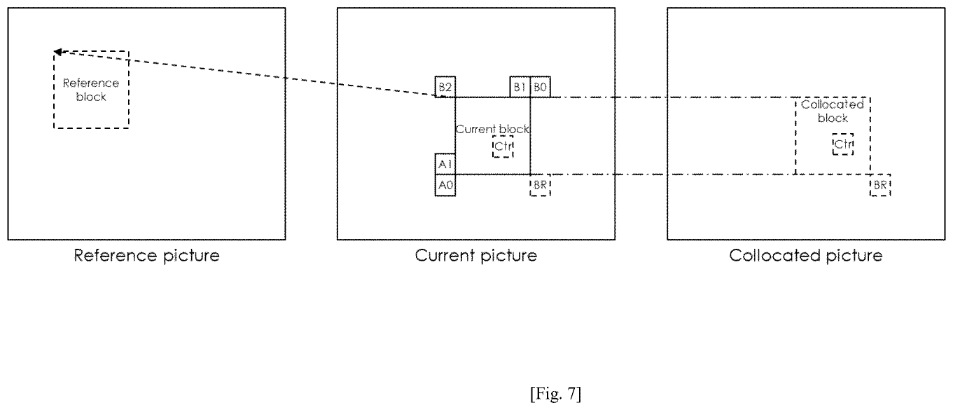

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

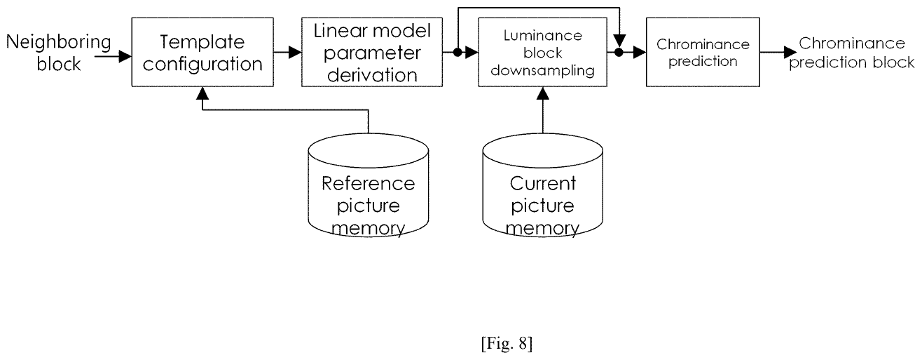

The encoder and decoder may first predict the chroma sample of the current block, based on the reconstructed luma block. Specifically, the encoder and decoder may acquire a model that models the relationship between the luma sample value and the value of the chroma sample, based on the neighboring sample values of the current block, and may predict the chroma block of the current block by using the acquired model and the luma block of the current block. Here, the model may include at least one of a linear model and a non-linear model. These embodiments will be described with reference to FIGS. 8 to 24.

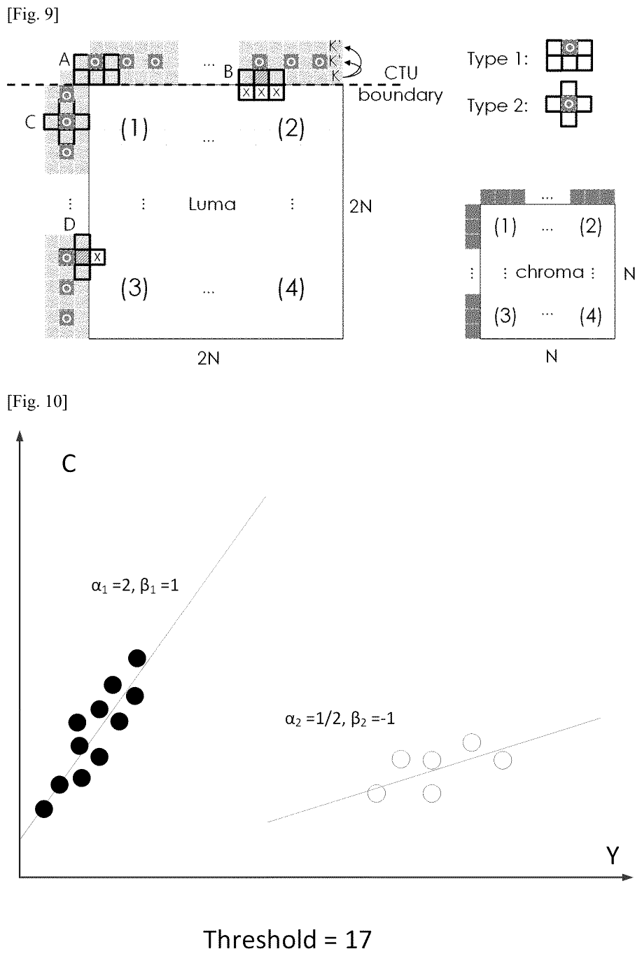

FIG. 8 illustrates a block diagram in which CCLM is performed according to an embodiment of the disclosure. In addition, FIG. 9 illustrates an example of a template configuration used to derive a linear model according to an embodiment of the disclosure.

When the encoder and decoder perform CCLM, the encoder and decoder are neighboring blocks adjacent to the current block, and may configure a template by using a reconstructed block. Here, the template is a set of reconstructed blocks used in the CCLM. The encoder and decoder derive the parameters of the linear model of CCLM, based on the configured template. Here, the luma block is down-sampled to match the size of the chroma block. The encoder and decoder predict the chroma block of the current block by using a linear model. In addition, more than two linear models may be used in CCLM. CCLM in which two or more linear models are used is referred to as a multi-model linear mode (MMLM).

A template may include only some of the neighboring pixels adjacent to the current block. In a specific embodiment, the template may include a pixel indicated by “O” in FIG. 9. When the 4:2:0 color format is used, the chroma block is ¼ the size of the luma block. For a 1:1 match between the luma pixel and the chroma pixel, down-sampled luma samples may be used in CCLM. In order to derive down-sampled luma samples, the encoder and decoder may use two types of filters. The type of filter to be used may be determined based on at least one of the SPS, PPS, PH, slice, tile, CU, and subblock of the current block. In addition, the bitstream may include information about a type of filter to be used in CCLM. The decoder may parse the information about the type of filter to be used in CCLM from the bitstream. In the embodiment of FIG. 9, the first type (Type 1) is a method of deriving the luma sample at the center “O” position by using 6 samples. In the embodiment of FIG. 9, the first type (Type 1) may be applied to position A to generate a down-sampled luma template. In this specification, a luma template represents a set of luma sample values acquired according to a predesignated method. In the embodiment of FIG. 9, the second type (Type 2) is a method of deriving a luma sample at the center position by using 5 samples. In the embodiment of FIG. 9, the second type (Type 2) may be applied to position C to generate a down-sampled luma template.

A method of acquiring a down-sampled luma template will be described.

In FIG. 9, “B” illustrates a method of configuring a down-sampled luma template according to an embodiment of the disclosure. When a filter of the first type (Type 1) is applied, the encoder and decoder may use the top three samples of the first type (Type 1) for the reconstructed luma samples of blocks around the current block. In addition, the bottom three samples of the first type (Type 1) may be used for the reconstructed luma samples within the current block. The position of the final generated luma pixel may be the hatched portion of FIG. 9. This operation may be equally applied to the second type (Type 2).

In another specific embodiment, the encoder and decoder may configure a down-sampled luma template by using only the top three samples of the first type (Type 1). The position of the final generated luma pixel may be the hatched portion of FIG. 9. This operation may be equally applied to the second type (Type 2). Parallel processing performance may be improved through these embodiments.

In another specific embodiment, when a boundary above the current block is a CTU boundary, the encoder and decoder may configure a template by using only one line closest to the current block among the top three pixel lines. Here, one adjacent line sample may be padded into the second and third lines so that the existing filter types of first type (Type 1) and second type (Type 2) can be applied. These embodiments may save memory on the line buffer.

The encoder may select a sample that has a good encoding efficiency from among a sample adjacent to the left of the current block, a sample adjacent to the top of the current block, and both a sample adjacent to the left and a sample adjacent to the top of the current block, and may use the selected sample as a template. The bitstream may include information about the position of the sample used as a template for the CCLM or MMLM, i.e., information about the template position. The decoder may parse information about the template position from the bitstream and configure a template based on the information about the template position. However, this signaling method may be a factor of increasing the amount of bits. Therefore, the encoder and decoder may implicitly determine the template position through the following embodiments. For convenience of explanation, a sample adjacent to the left of the current block is referred to as a left sample, and a sample adjacent to the top of the current block is referred to as a top sample.

In a specific embodiment, the encoder and decoder may determine the position of the template based on an intra-prediction directional mode. Specifically, the encoder and decoder may determine a sample close to the direction indicated by the intra-prediction directional mode used for prediction of the current luma block among the top sample and a sample adjacent to both the left and the top as the template position. For example, when the direction indicated by the intra-prediction directional mode is closer to the top sample than the left sample or has a predesignated value, the encoder and decoder may use only the top template as a template for the CCLM or MMLM. In addition, when the direction indicated by the intra-prediction directional mode is closer to the left sample than the top sample or has a predesignated value, the encoder and decoder may use only the left template as a template for CCLM. In a specific embodiment, the predesignated value may be 50 and 18. Here, when the value of the intra-prediction directional mode is greater than 50, the encoder and decoder may use the top sample as a template for the CCLM or MMLM. In addition, when the value of the intra-prediction directional mode is less than 18, the encoder and decoder may use the left sample as a template for CCLM. In addition, when the value of the intra-prediction directional mode is between 18 and 50, the encoder and decoder may use the top sample and left sample as a template for the CCLM or MMLM.

In another specific embodiment, when the encoder and decoder configure a template for the CCLM or MMLM, the encoder and decoder may determine a sample to be use among the top sample and a sample adjacent to both the left and the top by comparing the value of a quantization parameter used when reconstructing a neighboring block adjacent to the left and the value of a quantization parameter used when reconstructing a neighboring block adjacent to the top. Specifically, the encoder and decoder may use samples of a neighboring block to configure a template for the CCLM or MMLM, the neighboring block having a smaller value among the value of the quantization parameter used when reconstructing the neighboring block adjacent to the left and the value of the quantization parameter used when reconstructing the neighboring block adjacent to the top. When the value of the quantization parameter used to reconstruct the neighboring block adjacent to the left and the value of the quantization parameter used to reconstruct the neighboring block adjacent to the top are the same or have a difference within a predesignated value, the encoder and decoder may configure the template for the CCLM or MMLM by using both the left sample and the top sample. According to this embodiment, samples reconstructed with higher image quality may be used for CCLM or MMLM. In another specific embodiment, the encoder and decoder may use samples of a neighboring block to configure a template for the CCLM or MMLM, the neighboring block having a larger value between the value of the quantization parameter used when reconstructing the neighboring block adjacent to the left and the value of the quantization parameter used when reconstructing the neighboring block adjacent to the top. Even in this embodiment, when the value of the quantization parameter used to reconstruct the neighboring block adjacent to the left and the value of the quantization parameter used to reconstruct the neighboring block adjacent to the top are the same or have a difference within a predesignated value, the encoder and decoder may configure the template for the CCLM or MMLM by using both the left sample and the top sample.

In another specific embodiment, the encoder and decoder may determine the position of the sample used for template configuration, based on the size of the current block. Specifically, the encoder and decoder may use both the left sample and the top sample as a template for the CCLM or MMLM if the size of the current block has a predesignated value or less. The size of the current block may be determined based on the sum of the width and height of the current block. In addition, the predesignated value may be an integer of 1 or greater.

In another specific embodiment, the encoder and decoder may determine the position of the sample used to configure a template, based on a width-to-height ratio of the current block. Specifically, when the width of the current block is longer than the length, the encoder and decoder may configure a template for the CCLM or MMLM by using the left sample. In another specific embodiment, when the width of the current block is longer than the length, the encoder and decoder may use the top sample to configure a template for CCLM.

In another specific embodiment, the encoder and decoder may determine the position of the sample used to configure a template, based on whether the left sample is reconstructed by applying the CCLM or MMLM and the top sample is reconstructed by applying the CCLM or MMLM. Specifically, when the CCLM and MMLM have not been applied to reconstruct the left sample, and the CCLM or MMLM has been applied to reconstruct the top sample, the encoder and decoder may configure a template for the CCLM or MMLM by using the top sample. In another specific embodiment, when the CCLM and MMLM have not been applied to reconstruct the left sample, and the CCLM or MMLM has been applied to reconstruct the top sample, the encoder and decoder may configure a template for the CCLM or MMLM by using the left sample.

In another specific embodiment, the encoder and decoder may determine the position of a sample used to configure the template, based on the number of pixels on which reference sample padding has been performed in samples of a left neighboring block of the current block or the number of pixels on which reference sample padding has been performed in samples of a top neighboring block of the current block. Specifically, when the number of pixels on which reference sample padding has been performed in the sample of the left neighboring block of the current block is a predesignated value or more, the encoder and decoder may configure the template for the CCLM or MMLM without using the left sample. Here, the predesignated value may be an integer of 1 or greater. Specifically, when the number of pixels on which reference sample padding has been performed in the samples of the top neighboring block of the current block is a predesignated value or more, the encoder and decoder may configure the template for the CCLM or MMLM without using the top sample. Here, the predesignated value may be an integer of 1 or greater. In addition, when both left and top samples are not available, the encoder and decoder may derive a linear model by using predesignated default parameters.

In another specific embodiment, when the number of samples included in the template is a predesignated value or less, the encoder and decoder may derive a linear model by using a predesignated basic parameter. The predesignated value may be an integer of 1 or greater.

In the embodiments described above, the predesignated basic parameter A1 may have a value of 0, B1 may have a value of X, and the shift may have a value of 0. Here, X may be half of the maximum value of the range of the current video format. For example, when the current video format has an 8-bit range, X may be 128.

FIG. 10 illustrates that an encoder and a decoder according to an embodiment of the disclosure derive two linear models, based on a threshold.

Neighboring pixels used to configure a template may be pixels before deblocking filtering is applied. In addition, when LMCS is applied to neighboring pixels used in template configuration, pixels before inverse mapping is performed may be used. In another specific embodiment, when LMCS is applied to neighboring pixels used in template configuration, pixels after inverse mapping is performed may be used.

The encoder and decoder may acquire the parameters of the linear model by using the configured template. More than one linear model may be used for each block. The encoder may include, in the bitstream, information indicating the number of linear models to be used for each block. The decoder may parse information indicating the number of linear models to be used for each block from the bitstream, and may derive linear models for the current chroma block, based on the information indicating the number of linear models to be used.

A method in which the encoder and decoder derive a linear model may include the least mean square (LMS) method and the MIN/MAX method.

First, the MIN/MAX method will be explained. In the MIN/MAX method according to an embodiment of the disclosure, the encoder and decoder discover two small values (X⁰_{A}, X¹_{A}) and two large values (X⁰_{B}, X¹_{B}). In addition, the encoder and decoder derive the average of small values (X_{A}, Y_{A}) and the average of large values (X_{B}, Y_{B}) by using the values of the chroma samples (Y⁰_{A}, Y¹_{A}, Y⁰_{B}, Y¹_{B}) corresponding to the four samples and Equation 1. The encoder and decoder calculate the final linear model parameters “a” and “b” by using Equation 2. When the encoder and decoder predict the chroma block, the encoder and decoder may predict each sample of the chroma block by using linear model parameters (a, b) and luma sample values, as shown in Equation 3.

$$\begin{matrix}{X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \\ {Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1\end{matrix} \qquad Equation 1$$

$$\begin{matrix}α = \frac{{Y}_{α} - {Y}_{b}}{{X}_{a} - {X}_{b}} & β = {Y}_{b} - α \cdot {X}_{b}\end{matrix} \qquad Equation 2$$

$$pre {d}_{C} ( i , j ) = α \cdot {rec}_{L}^{′} ( i , j ) + β \qquad Equation 3$$

The LMS method is explained. The encoder and decoder may acquire the parameter value of the linear model by using the template and Equation 4 and Equation 5. In Equation 4, Rec_{C}(i) and Rec′_{L}(i) refer to the chroma sample and down-sampled luma sample in the template, respectively, and I refers to the number of samples in the template. In FIG. 9, I refers to the sample at the position marked in gray.

$$α = \frac{I \times {\sum }_{i = 0}^{I} {Rec}_{C} ( i ) \times {Rec}_{L}^{′} ( i ) - {\sum }_{i = 0}^{I} {Rec}_{C} ( i ) \times {\sum }_{i = 0}^{I} {Rec}_{L}^{′} ( i )}{I \times {\sum }_{i = 0}^{I} {Rec}_{L}^{′} ( i ) \times {Rec}_{L}^{′} ( i ) - {( {\sum }_{i = 0}^{I} {Rec}_{L}^{′} ( i ) )}^{2}} = \frac{{A}_{1}}{{A}_{2}} \qquad Equation 4$$

$$β = \frac{{\sum }_{i = 0}^{I} {Rec}_{C} ( i ) - α \cdot {\sum }_{i = 0}^{I} {Rec}_{L}^{′} ( i )}{I} \qquad Equation 5$$

To improve coding efficiency in LM mode, the encoder and decoder may use two or more linear models instead of just one linear model. Specifically, the encoder and decoder may use a mixture of a CCLM mode using only one existing linear model and a MMLM mode using two or more linear models. Here, information regarding the selection of the linear model may be signaled in CU units.

In the case of the MMLM mode using two or more linear models, the computational complexity may increase as the number of linear models increases. Therefore, as shown in FIG. 10, it may be limited to use only two linear models.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad Equation 6$$

In a specific embodiment, a method for deriving parameters for two linear models may be performed in the following order.

The encoder and decoder calculate the average value of the samples in a luma template and the average value of the samples in a chroma template. In this specification, a chroma template represents a set of chroma sample values acquired according to a predesignated method. Here, in order to more accurately distinguish between two linear models, the encoder and decoder may use, as the average value of each template, an average value scaled to an extended range by the number of samples of each template. In addition, the encoder and decoder may use either a template containing down-sampled luma sample values or a template containing luma sample values before downsampling as the average value for samples in the luma template.

The encoders and decoder configure the parameters for the linear model to have default values. Here, the encoder and decoder may configure A1 and A2 to have a value of 0, and may configure B1 and B2 to have a value equal to half the maximum value of the range of the current video format. For example, when the range of the video format is 8 bits, the encoder and decoder may configure B1 and B2 to have a value of 128. In addition, the encoder and decoder configure the shift value to be 0 in order to reconstruct the scaled value to its original state. When the number of samples included in the template is a predesignated value or less, the encoder and decoder may use two linear models with default parameters for the CCML or MMLM. The predesignated value may be an integer of 1 or greater. The predesignated value may be 4. The encoder and decoder divide chroma samples at the same position as each of the samples of the luma template into two groups according to the scaled average value of the samples in the luma template. Specifically, the encoder and decoder may classify samples having a value equal to or less than the average value into a first group, and samples having a value greater than the average value into a second group.

When the number of samples in each group is not a multiple of 2, the encoder and decoder perform padding through neighboring samples so that the number of samples in each group is a multiple of 2. Here, when the number of samples in each group is a predesignated number or less, the encoder and decoder do not perform padding. The predesignated number may be an integer of 1 or greater. In another specific embodiment, when the number of samples in a group is a predesignated number or less, the encoder and decoder may not derive two linear models but only one linear model. The predesignated number may be an integer of 1 or greater. For example, the predesignated number may be 4.

The encoder and decoder derive parameters for the linear model for each group by using Equation 4 and Equation 5. Here, when the number of samples in each group is a predesignated number or less, the encoder and decoder obtain a difference value by subtracting the average value of the samples in the luma template from the average value of the samples in the chroma template. The encoder and decoder end the linear model derivation process for the corresponding group by substituting the obtained difference value into the parameter B value for the linear model. In another specific embodiment, when the number of samples in a group is a predesignated number or less, the encoder and decoder may not derive two linear models but only one linear model. The predesignated number may be an integer of 1 or greater. For example, the predesignated number may be 4.

In a multi-CCP model such as MMLM and MM-CCCM, the following different methods may be used to derive the parameters for a linear model more accurately.

The encoder and decoder may use the average value of the reconstructed luma block within the current block instead of the average value of the luma template of neighboring blocks adjacent to the current block. In another specific embodiment, the encoder and decoder may use the average value between the average value of the current luma block and the average value of the luma template as a threshold for distinguishing between two linear models. The threshold may be compared with the luma sample value at the position of the sample finally generated by applying a down-sampling filter to the neighboring luma samples of the current block. Specifically, depending on whether the luma sample value at the position of the sample finally generated by applying the down-sampling filter to the neighboring luma samples of the current block is greater than the threshold, the encoder and decoder may determine a linear model among the two linear models, derived using the neighboring luma sample of the current block. Here, the down-sampling filter is a filter used to match the number of luma samples to the number of chroma samples. Depending on a chroma format and a ratio between a luma component and a chroma component, the average value of the luma block of the neighboring block may be the average value of the down-sampled luma component. Under the same condition, the average value of the luma block of the current block may also be the average value of the down-sampled luma blocks.

In another specific embodiment, the encoder and decoder may use an average value calculated using at least one of the pixel value of the luma template for a neighboring block adjacent to the current block and the pixel value of the reconstructed luma block within the current block. In another specific embodiment, the encoder and decoder may use one of the average value of the current luma block and the average value of the luma template as a threshold for distinguishing between two linear models. Depending on the chroma format and the ratio between the luma component and the chroma component, the average value of the luma block of the neighboring block may be the average value for the down-sampled luma components. Under the same condition, the average value of the luma block of the current block may also be the average value of the down-sampled luma blocks. In addition, depending on the chroma format and the ratio between the luma component and the chroma component, the average value of the luma template and the luma block may be the average value of the luma template and the luma block before downsampling.

In another specific embodiment, a weight for calculating the average value between the luma template and the reconstructed luma block within the current block may differ according to the size of the current block. Specifically, when the size of the current block is equal to or smaller than a predesignated size, the encoder and decoder may calculate the average value by multiplying the pixel value of the luma template by a first weight and multiplying the pixel value of the reconstructed luma block within the current block by a second weight. The calculated average value may be used as a threshold to distinguish between the two models in the MMLM method. Here, the predesignated size may be determined differently depending on the horizontal size and vertical size of the current block. In a specific embodiment, the predesignated size may be the sum of the horizontal size and vertical size of the current block. For example, the predesignated size may be 12. In addition, the first weight and the second weight may be integers. The second weight may be configured to be larger than the first weight. In another specific embodiment, the second weight may be configured to be less than the first weight. For example, the first weight may be configured to be 1 and the second weight may be configured to be 4. In addition, the average value calculation may differ depending on the weight. When the second weight is 4, the average value may be calculated by considering the size of the current block to be four times larger. This allows the weight of the current block to be increased even if the size of the current block is small at the time of calculating the average value.

In another specific embodiment, the average value of the chroma template may be used instead of the average value of the luma template to distinguish between two linear models. Here, the average value of each chroma template may be used for each of the two chroma components. In addition, two linear models may be derived for each chroma component. Here, the encoder and decoder may use the average value of the samples of the luma templates, which are divided into two luma templates by using the average value of the chroma template, as a threshold for application of the two linear models to the currently reconstructed luma block. Specifically, the encoder and decoder may select a linear model to be applied to the samples of the currently reconstructed luma block by using the average value of the two luma averages for the luma template.

In another specific embodiment, the encoder may include information indicating a threshold for distinguishing between two linear models in the bitstream. The decoder may parse the information indicating a threshold for distinguishing between two linear models from the bitstream, and may distinguish between the two linear models based on the information indicating a threshold for distinguishing between the two parsed linear models. Here, the information indicating a threshold for distinguishing between two linear models may be an index indicating one of predesignated values. Pre-designated values may include thresholds used in neighboring blocks. In another specific embodiment, the information indicating a threshold for distinguishing between linear models may be a threshold value. The information indicating a threshold for distinguishing between linear models may be included in the bitstream in units of blocks. In addition, the encoder may include, in the bitstream, a flag indicating whether the information indicating the threshold for distinguishing between linear models directly indicates the threshold value or indicates one of predesignated candidates. The decoder may parse the corresponding flag from the bitstream and acquire a threshold for distinguishing between linear models based on the parsed flag. In addition, the number of predesignated values may be predesignated. In addition, predesignated values may be managed according to FIFO. Therefore, when a value is added to the predesignated values, one of the predesignated values may be excluded.

The number of linear models for the encoder and decoder may be derived according to the following embodiments.

In a specific embodiment, when the reference line index used to construct the prediction sample for the current luma block has a value greater than 1, the encoder and decoder may use only one linear model. In another specific embodiment, when the reference line index has a value greater than 1, the encoder and decoder may use two linear models. This is because if the reference line index used to construct the prediction sample for the current luma block has a value greater than 1, it is likely to be a block that changes linearly.

In another specific embodiment, when the reference line index used to construct the prediction sample for the current luma block has a value of 0, the decoder may predict the chroma block by using only one linear model. This is because if the reference line index has a value of 0, it may be determined that samples adjacent to the current block are used. Here, the encoder may not include a syntax element related to the CCLM and MMLM in the bitstream. In addition, the decoder may determine whether to parse a syntax element related to the CCLM and MMLM according to the reference line index. When the reference line index has a value of 0, the decoder may omit to parse the syntax element related to the CCLM and MMLM. Here, the decoder may infer that the CCLM mode applied to the current block is a CCLM mode in which only one linear model is used.

In another specific embodiment, the encoder and decoder may determine the number of linear models according to the horizontal size or vertical size of the current block. Specifically, when the horizontal size or vertical size of the current block has a predesignated value or less, only one linear model may be used. In another specific embodiment, when the horizontal size or vertical size of the current block has a predesignated value or greater, only one linear model may be used. In these embodiments, the predesignated value may be an integer of 1 or greater.

In another specific embodiment, when the size of the current block is equal to or larger than a predesignated size, the encoder and decoder may divide the current block into subblocks and use each linear model for each divided subblock. Here, the encoder and decoder may use the reconstructed samples of the neighboring blocks located closest to the subblock as a template for deriving the linear model of the subblock. For example, in FIG. 9, the current block may be divided into four subblocks. Here, the encoder and decoder may use both the left and top templates for a first subblock. In addition, the encoder and decoder may only use the top template for a second subblock. In addition, the encoder and decoder may only use the left template for a third subblock. In addition, the encoder and decoder may derive a linear model for a fourth template by using both the top template for the second subblock and the left template for the third subblock. Here, at least one linear model may be derived for each subblock.

In another specific embodiment, the encoder and decoder may determine the number of linear models of the current block by using at least one of an intra-prediction mode of the current luma block, a coefficient distribution of the residual block of the current luma block, a quantization parameter of the current block, and whether the CCLM or MMLM of neighboring blocks is used. Specifically, when there is one or more blocks using the MMLM among neighboring blocks, the encoder and decoder may apply the MMLM to the current block. When the CCLM has been used in all neighboring blocks, the encoder and decoder may apply the CCLM to the current block.

In another specific embodiment, the encoder and decoder may acquire two linear models for the current block signaling that the MMLM has been used. Here, the encoder and decoder may reconfigure the mode for the current block to be the CCLM and use one linear model by using the similarity between parameter values of the two linear models. Here, when the encoder and decoder determine the similarity between parameter values of two linear models, the encoder and decoder may use at least one of the similarity between a1 and a2 and the similarity between b1 and b2 in Equation 6. Here, when the difference between the absolute values of the two values is within a predesignated value, the encoder and decoder may determine that the parameter values of the two linear models are similar. The predesignated value may be an integer of 1 or greater. In addition, since there are two chroma components, the number of linear models may differ for each two chroma components.

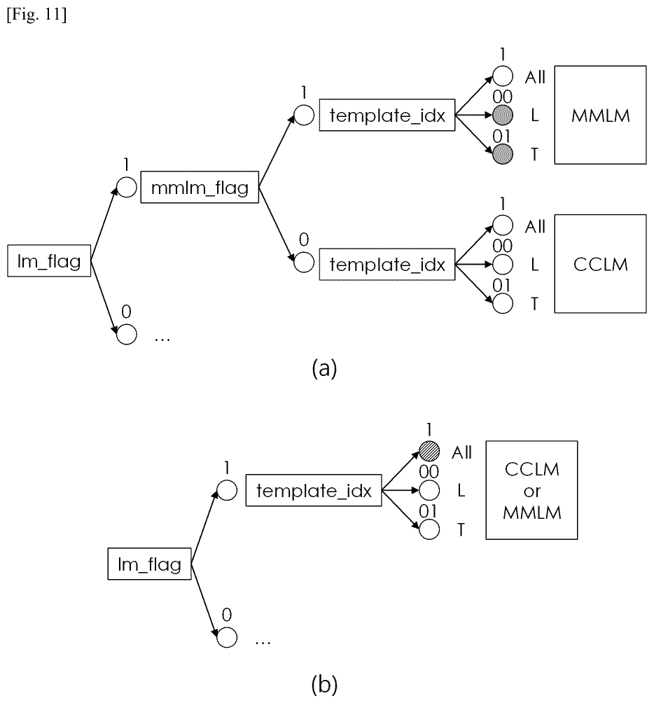

FIG. 11 illustrates a method of configuring syntax for a coding mode of a linear model according to an embodiment of the disclosure.

In general, the same intra-prediction directional mode for two chroma components (Cb, Cr) is applied. Therefore, the same number of linear models may be applied to the two chroma components. In another specific embodiment, in order to increase coding efficiency, an intra-prediction mode may be signaled for each chroma component. The number of linear models may be determined for each two chroma components. Specifically, a horizontal intra-prediction mode may be applied to the chroma component Cb, and a prediction mode using two linear models may be applied to the chroma component Cr. In another specific embodiment, information as to whether LM mode, CCLM, or MMLM is applied to two chroma components is first signaled, and then information as to whether the CCLM or MMLM is applied to each chroma component may be additionally signaled. In another specific embodiment, after signaling whether to apply the MMLM to the two chroma components, the similarity of the two linear models derived for each chroma component may be determined. Here, the decoder may implicitly determine whether to apply the CCLM or MMLM. In this embodiment, since additional information about each chroma component is not signaled, the bit amount may be reduced.

For the TIMD coding mode, two intra-prediction directional modes are used to generate the luma prediction block. This TIMD coding mode may be usefully applied to blocks in which directional characteristics do not clearly exist. Specifically, when the TIMD mode is applied to the current block, the encoder and decoder may implicitly configure the intra-prediction mode of the chroma block of the current block to the CCLM or MMLM mode. Specifically, the encoder and decoder may determine whether to apply the CCP mode to the current chroma block according to the coding mode of the current block. Here, information as to whether the CCLM and MMLM is to be used may be signaled. In addition, information as to whether the CCLM or MMLM is to be used may be signaled for each chroma component and included in the bitstream. When the current block is in the TIMD mode, the decoder may parse the corresponding information about the chroma component and determine whether to apply the CCLM or MMLM according to the parsed information. In another specific embodiment, without signaling for the chroma component, the decoder may determine whether to apply the CCLM instead of the MMLM according to the method for deriving the number of linear models described above after configuring that the MMLM has been applied. In addition, it may be implicitly determined that the mode for the chroma signal uses the CCLM or MMLM not only in blocks encoded in the TIMD mode, but also in blocks encoded in the MIP and DIMD modes.

When the encoder and decoder use the TIMD and DIMD coding modes, prediction blocks are generated using two intra-prediction directional modes, respectively, and the final prediction block is generated by performing weight averaging of each of prediction blocks. The encoder and decoder may acquire a reconstructed luma block by adding the residual block to a final prediction block. Thereafter, the CCLM or MMLM is performed on the chroma block by using the reconstructed luma block, thus increasing the number of processing operations and decreasing the processing speed. Therefore, the encoder and decoder may use the final predicted luma block instead of using the reconstructed luma block as a luma block for the CCLM or MMLM. According to these embodiments, processing speed may be improved. In addition, the final predicted luma block may be less accurate than the reconstructed luma block. Therefore, the encoder may include, in the bitstream, information as to which level of the luma block is to be used for the CCLM or MMLM. The decoder may parse the information and determine, based on the parsed information, whether the final predicted luma block or the reconstructed luma block is to be referred to during performing of the CCLM or MMLM.

Intra-prediction directional modes for chroma blocks may be broadly divided into a derived mode (DM), an explicit mode (EM), and a linear model (LM). The DM mode is a mode using the intra-prediction directional mode of the luma block as the intra-prediction directional mode of the chroma block. The derived Mode (DM) mode may also be referred to as a direct mode (DM). The EM mode is a mode that designates the intra-prediction directional mode of the chroma block as one of planar, DC, horizontal, and vertical direction modes, and is applied differently from the intra-prediction directional mode of the luma block. The EM mode may also be referred to as a non-direct mode. The LM mode is a mode in which a chroma block is predicted through a reconstructed luma block and a linear model, and has different characteristics from an existing angular mode and a non-angular mode (planar or DC).

When the intra-prediction directional mode for such a chroma block is signaled, whether the LM mode is applied to the current block may be signaled before the intra-prediction directional mode. When the LM mode is not applied to the current block, information about the DM mode or EM mode may be signaled. When the LM mode is applied to the current block, information as to whether the CCLM or MMLM is applied and information about the position of the sample used in the template for acquiring a linear model may be signaled. Specifically, signaling may be performed according to the following embodiments.

In a specific embodiment, a signaling method such as (a) of FIG. 11 may be used. The encoder and decoder parse lm_flag. When the value of lm_flag is 0, the encoder and decoder may determine that the LM mode is not used for the current block. Here, the encoder and decoder parse information about the EM and DM modes from the bitstream. When the value of lm_flag is 1, the encoder and decoder determine that the LM mode is used for the current block. Here, the encoder and decoder parse mmlm_flag. When the value of mmlm_flag is 1, the encoder and decoder determine that the MMLM is applied to the current block. In addition, the encoder and decoder parse template_idx, which is information about a template to be used in the MMLM. When the binary codeword of template_idx is “1”, the encoder and decoder use both the left template and the top template to derive a linear model. When the binary codeword of template_idx is “00”, the encoder and decoder derive a linear model by using only the left template. When the binary codeword of template_idx is “01”, the encoder and decoder derive a linear model by using only the top template. When the value of mmlm_flag is 0, the encoder and decoder determine that the CCLM is applied to the current block. Here, the encoder and decoder parse template_idx indicating a template to be used in the CCLM, and determine a template that is applied to a CCLM, as in the operation described above.

When a multi-CCP model such as MMLM and MM-CCCM is applied, the encoder and decoder should derive two or more linear models. A large number of samples may be required, and using both the left and top templates may be effective. Accordingly, the signaling method in (a) of FIG. 11 may be changed as follows. The encoder and decoder parse lm_flag. When the value of lm_flag is 0, the encoder and decoder determine that the LM mode is not applied to the current block. Here, the encoder and decoder parse information about the EM and DM modes. When the value of lm_flag is 1, the encoder and decoder determine that the LM mode is applied to the current block and parse mmlm_flag. When the value of mmlm_flag is 1, the encoder and decoder determine that the MMLM is applied to the current block. Here, the encoder and decoder may infer that both the left template and the top template are used. Specifically, the encoder and decoder may infer template_idx as I instead of parsing the same. This is because it may be effective to use both the left template and the top template when the MMLM is applied.

When the value of mmlm_flag is 0, the encoder and decoder may determine that the CCLM is applied to the current block. Here, the encoder and decoder parse template_idx, which indicates a template to be used for the CCLM. When the binary codeword of Template_idx is “1”, a linear model is derived using both the left and top templates. When the binary codeword of template_idx is “00”, the encoder and decoder derive a linear model by using only the left template. When the binary codeword of template_idx is “01”, the encoder and decoder derive a linear model by using only the top template. When the value of mmlm_flag is 1, the encoder and decoder may determine whether to parse template_idx by using at least one of the intra-prediction mode of the current luma block, the encoding block size, the characteristics of the residual block, the quantization parameter, whether the CCLM and MMLM are applied to the neighboring block, and the reference line index. When the encoder and decoder omit to parse template_idx, the encoder and decoder may infer the value of template_idx as a predesignated value. For example, when the size of the current block is a predesignated size or less, the encoder and decoder may not parse template_idx. Here, the encoder and decoder may infer that the value of template_idx is 1. The predesignated size may be an integer of 1 or greater.

In another specific embodiment, a signaling method such as (b) in FIG. 11 may be used. The encoder and decoder parse lm_flag. When the value of lm_flag is “0”, the encoder and decoder determine that the LM mode is not applied to the current block. Here, the encoder and decoder parse information about the EM and DM modes. When the value of lm_flag is 1, the encoder and decoder determine that the LM mode is applied to the current block. Here, the encoder and decoder parse template_idx, which is information about a template to be used. When the binary codeword of template_idx is “1”, the encoder and decoder use both the left template and the top template to derive a linear model. When the binary codeword of template_idx is “00”, the encoder and decoder derive a linear model by using only the left template. When the binary codeword of template_idx is “01”, the encoder and decoder derive a linear model by using only the top template. Here, the encoder and decoder may determine a model to be used among the CCLM and MMLM modes according to the method of determining the similarity between the parameters of the two linear models described above.

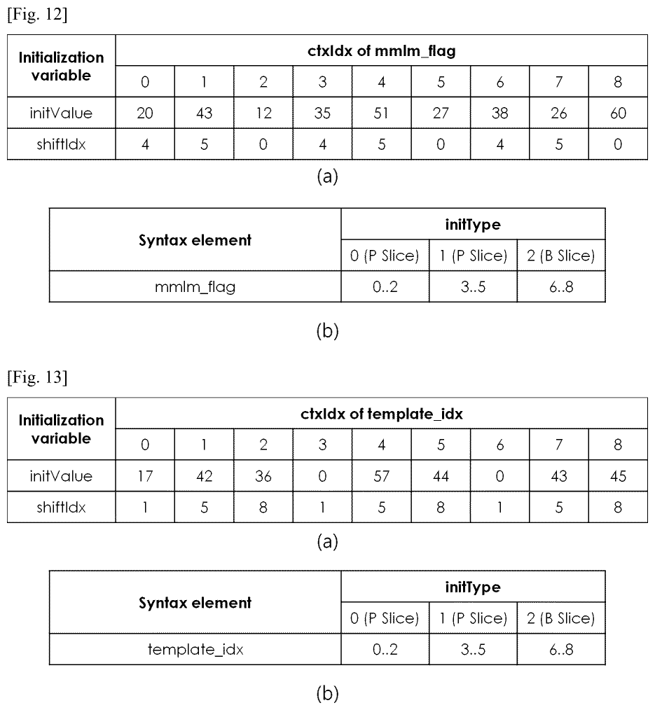

FIGS. 12 and 13 show probability initialization information for the mmlm_flag context model according to an embodiment of the disclosure.

The encoder may entropy code the mmlm_flag and template_idx by using context adaptive binary arithmetic coding (CABAC). The context model for the mmlm_flag and template_idx may be designated as values acquired through experimentation. In (a) of FIG. 12 and (a) of FIG. 13, init Value represents the context model for mmlm_flag and template_idx. In addition, shiftIdx is used when updating the probability for the mmlm_flag and template_idx. The init Value is determined depending on whether the current slice type is I slice, P slice, or B slice. (b) of FIG. 12 and (b) of FIG. 13 show context models that may be used according to each slice type. When the type of the current slice is I slice, the value of initType may be configured to be one of 0 to 2. When the type of the current slice is P slice, the value of initType may be configured to be one of 3 to 5. When the type of the current slice is B slice, the value of initType may be configured to be one of 6 to 8.

There may be at least one initType value used for each slice type. When only one value of initType is defined for each slice, if the type of the current slice is I slice, the value of initType is 0, the value of init Value for mmlm_flag corresponding to 0 is 20, and the value of init Value for template_idx corresponding to 0 may be 17. In addition, when the type of the current slice is P slice, the value of initType may be 3, the value of init Value for mmlm_flag corresponding to 3 may be 35, and the value of init Value for template_idx corresponding to 3 may be 0. When the type of the current slice is B slice, the value of initType may be 6, the value of init Value for mmlm_flag corresponding to 6 may be 38, and the value of initValue for template_idx corresponding to 6 may be 0.

In addition, the value of initType according to slice type may be determined for each slice. In a specific embodiment, the order of use of the initType value may be determined according to the value of sh_cabac_init_flag defined in the slice header. When the value of sh_cabac_init_flag is 1 and the type of the current slice is P slice, the value of initType may be 6. In addition, when the value of sh_cabac_init_flag is I and the type of the current slice is B slice, the value of initType may be 3. When the value of sh_cabac_init_flag is 0 and the type of the current slice is P slice, the value of initType may be 3. When the value of sh_cabac_init_flag is 0 and the type of the current slice is B slice, the value of initType may be 6.

In connection with the mmlm_flag symbol currently being encoded or parsed, one of a plurality of context models may be selected based on at least one of the intra-prediction mode of the current luma block, the type of the encoding block, the quantization parameter, whether the CCLM or MMLM is used in a neighboring block, the characteristics of the residual block, the motion information difference value, and the reference line index. Here, the shape of the encoding block may include at least one of the horizontal size or vertical size of the encoding block, the width-to-height ratio of the encoding block, and the difference between the width and height of the encoding block.

In addition, the characteristics of the residual block may include at least one of the presence or absence of a residual signal of the luma block and the position of the last transform coefficient. Specifically, a context model may be selected according to the following embodiments.

The context model of mmlm_flag may be selected based on the value of mmlm_flag of the neighboring block of the current block. Specifically, the context index indicated by the context model of mmlm_flag may be determined based on the sum of the mmlm_flag value of the left neighboring block adjacent to the current block and the mmlm_flag value of the top neighboring block adjacent to the current block. Here, the value of the context index may be one of values of 0 to 2. When the neighboring block is in an unusable position, 0 may be added in the mmlm_flag sum operation described above.

In another specific embodiment, the context model of mmlm_flag may be selected according to the size of the current block. Specifically, when the size of the current block is larger than the predesignated first value, the value of the context index may be 2. In addition, when the size of the current block is smaller than the predesignated second value, the value of the context index may be 0. In other cases, the value of the context index may be 1. Here, the first predesignated value may be 32×32. In addition, the predesignated second value may be 16×16. In another specific embodiment, the predesignated first value and the predesignated second value may be determined based on the sum of the horizontal size and vertical size of the current block.

In another specific embodiment, the context of mmlm_flag may be selected based on the difference between the horizontal size and vertical size of the current block. Specifically, when the horizontal size and vertical size of the current block are the same, the context index of mmlm_flag may be 0. When the vertical size is larger than the horizontal size, the context index may be 1. When the vertical size is smaller than the horizontal size, the context index of mmlm_flag may be 2.

In another specific embodiment, instead of binary arithmetic encoding the mmlm_flag through a context model, a bypass type of binary arithmetic encoding using a fixed probability interval may be performed.

In another specific embodiment, the mmlm_flag may be encoded in binary arithmetic using only one context model. In this embodiment, the context model index is not derived, and a fixed context model may be used for all blocks in the slice. This is because each slice type has only one context model.

In connection with the symbol of template_idx to be currently coded or parsed, one of a plurality of context models may be selected based on at least one of the intra-prediction mode of the current luma block, the type of the encoding block, the quantization parameter, whether the CCLM or MMLM is used in the neighboring block, the characteristics of the residual block, the motion information difference value, and the reference line index. Here, the shape of the encoding block may include at least one of the horizontal size or vertical size of the encoding block, the width-to-height ratio of the encoding block, and the difference between the width and height of the encoding block. In addition, the characteristics of the residual block may include at least one of the presence or absence of a residual signal of the luma block and the position of the last transform coefficient. In these embodiments, template_idx is configured by two bins, a context model technique is applied to the first bin, and binary arithmetic encoding in the form of a bypass is performed for the second bin or a fixed context model may be used for the second bin.

In another specific embodiment, the context model of template_idx may be selected according to the size of the current block. Specifically, when the size of the current block is larger than a predesignated first value, the value of the context index may be 2. In addition, when the size of the current block is smaller than a predesignated second value, the value of the context index may be 0. In other cases, the value of the context index may be 1. Here, the first predesignated value may be 32×32. In addition, the predesignated second value may be 16×16. In another specific embodiment, the predesignated first value and the predesignated second value may be determined based on the sum of the horizontal size and vertical size of the current block.

In another specific embodiment, the context of template_idx may be selected based on the difference between the horizontal size and vertical size of the current block. Specifically, when the horizontal size and vertical size of the current block are the same, the context index of template_idx may be 0. When the vertical size is larger than the horizontal size, the context index may be 1. When the vertical size is smaller than the horizontal size, the context index of template_idx may be 2.

In another specific embodiment, instead of binary arithmetic coding of template_idx through a context model, binary arithmetic coding in the form of a bypass using a fixed probability interval may be performed.

In another specific embodiment, template_idx may be encoded in binary arithmetic using only one context model. In this embodiment, the context model index is not derived, and a fixed context model may be used for all blocks in the slice. This is because each slice type has only one context model.

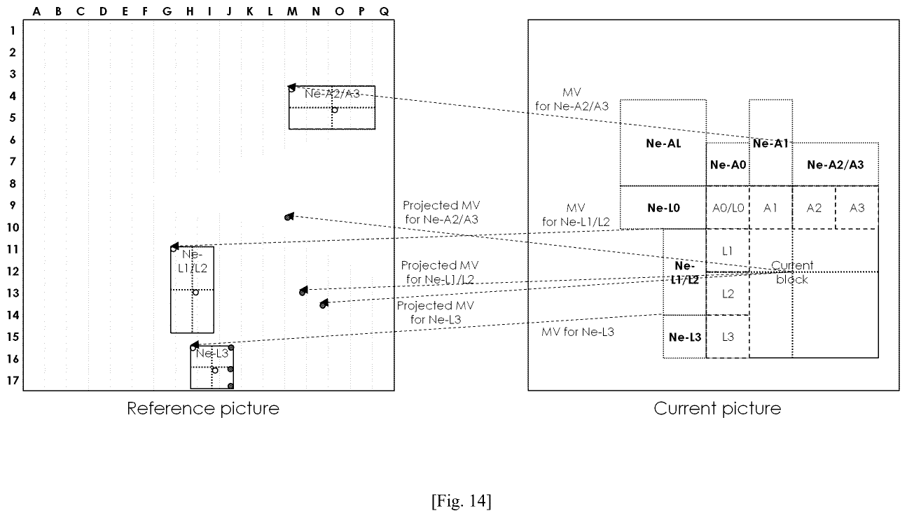

FIG. 14 illustrates a scheme of deriving an intra-prediction mode for the current block by using motion information of a neighboring block according to an embodiment of the disclosure.

Since the LM encoding method uses a reconstructed luma block and a linear model, it may be used for the chroma block of an intra-coded block or an inter-coded block. The inter-coding mode has low dependency on neighboring blocks, and thus processing speed may be increased. The LM encoding method is highly dependent on neighboring blocks, and thus processing speed may be slowed down. When the LM encoding method is applied in the inter-coding mode, the application may be difficult in encoding methods with low processing speed (GPM, Affine, sbTMVP, BCW, PROF, BDOF, TM, MP-DMVR, OBMC, MHP, LIC). The LM encoding method may be applied only to chroma blocks encoded in Merge, MergeSkip, MMVD, AMVP, SMVD, and CIIP, which are coding modes that have relatively high decoding processing speed for luma blocks. Specifically, the encoder and decoder may determine whether to allow the LM encoding method for the chroma block depending on the coding mode of the current block. Here, the bitstream may include information as to whether to apply the LM encoding method to the chroma block according to the coding mode of the current block. The decoder may parse the information according to the coding mode of the current block and determine whether to apply the LM encoding method to the chroma block of the block currently encoded in the inter-coding mode.

Methods for predicting blocks are broadly divided into an intra-prediction method using spatial correlation and an inter-prediction method using temporal correlation. When the current block is a block predicted by means of intra-prediction, the encoder and decoder include (store) information related to intra-prediction and do not store inter-prediction information. Here, the meaning of storing information by the encoder and decoder is to write information into the memory of the encoder and decoder, and the meaning of retrieving information is to read the information stored in the memory. Conversely, when the current block is a block predicted by means of inter-prediction, the encoder and decoder store information related to inter-prediction and do not store intra-prediction information. The encoding information of the current block may be predicted through encoded information of neighboring blocks. For example, when the current block is predicted by means of intra-prediction, the encoder and decoder may perform prediction for the current block, based on intra-prediction information of neighboring blocks. When the neighboring blocks are all predicted using inter-prediction, the prediction efficiency may decrease when the encoder and decoder predict the current block by using intra-prediction. To compensate for the decreased prediction efficiency, the encoder and decoder may store intra-prediction information for the block on which inter-prediction has been performed. This operation may improve the intra-prediction efficiency of a next block to be reconstructed. The method of deriving intra-prediction information from the block on which inter-prediction has been performed is used because the current block is likely to be similar to the image characteristics of the reference block. Specifically, the encoder and decoder may store the intra-prediction information of the reference block as the intra-prediction information for the current block.

FIG. 14 illustrates a method of, when there are neighboring blocks of various sizes around a current block, deriving an intra-prediction mode from the neighboring blocks. When the encoder and decoder encode the current block by using intra-prediction, the encoder and decoder encode construct an MPM list using an intra-prediction mode of neighboring blocks and then encode an intra-prediction mode for the current block by using the MPM list. Here, when the intra-prediction mode of a neighboring block is derived, if the neighboring block is a block on which inter-prediction has been performed, the encoder and decoder may derive the intra-prediction mode from a reference picture by using the motion information of the neighboring block. Here, the encoder and decoder may use an intra-prediction mode stored at a position moved by the motion information of a neighboring block from a position corresponding to a top-left pixel position of a neighboring block in the reference picture. In the case of the Ne-A2/A3 neighboring block in FIG. 14, the encoder and decoder may use an intra-prediction mode stored in M4 or O5 of the reference picture.

The intra-prediction mode of the current block may be similar to the intra-prediction mode of neighboring blocks. The closer the position used to derive the intra-prediction mode of a neighboring block to the current block, the more accurate the intra-prediction mode. Therefore, the encoder and decoder may reconfigure the position used to derive the intra-prediction mode of the neighboring block to a position close to the current block. In FIG. 14, when the encoder and decoder derive the intra-prediction mode for Ne-L3, the encoder and decoder may use the intra-prediction mode stored in J16 or J17 at a position close to the current block rather than H16 or I17. In addition, the encoder and decoder may derive an intra-prediction mode from a reference picture by projecting the motion information of neighboring blocks based on the position of the current block. In FIG. 14, in order to derive the intra-prediction mode for the neighboring block Ne-A2/A3, the encoder and decoder may not use an intra-prediction mode stored in M4, which is a position moved by the motion information of a neighboring block Ne-A2/A3 from a position corresponding to a top-left pixel position of the neighboring block Ne-A2/A3 in the reference picture. Here, in order to derive the intra-prediction mode for the neighboring blocks Ne-A2/A3, the encoder and decoder may derive an intra-prediction mode stored in M10, which is a position moved by the motion information of the neighboring block Ne-A2/A3 from a position corresponding to the central pixel position of the current block in the reference picture, and may use the derived intra-prediction mode as the intra-prediction mode for the neighboring block Ne-A2/A3. The encoder and decoder may add the derived intra-prediction mode to construct the MPM list of the current block. Here, the encoder and decoder may derive an intra-prediction mode stored at a position moved by the motion information of the neighboring block from a predesignated position within the current block, rather than the central pixel position of the current block. The predesignated position may be one of the following: top-left, top-middle, top-right, middle-left, bottom-left, bottom-middle, center, bottom-right, and middle-right of the current block. Here, the encoder and decoder may generate an intra-prediction block of the corresponding subblock by using at least one of several intra-prediction modes derived from motion information of several neighboring blocks. The encoder and decoder may use one of the median, average, minimum, and maximum values of the indices of each of the plurality of intra-prediction modes as the optimal intra-prediction mode.

The embodiments described above may be applied to derivation of the LM coding mode for the chroma block of the current block. Specifically, the encoder and decoder may derive an intra-prediction mode for the chroma block from the reference picture by using motion information of the neighboring block or the current luma block. Here, when the intra-prediction mode derived from the reference picture is an LM coding mode, the encoder and decoder may acquire, from the reference picture, at least one of information about a mode being used among CCLM, MMLM, CCCM, and GLM, information on whether the template has used from the sample on the left, the sample at the top, or both the sample on the left and the sample at the top, and a filter coefficient, and may use the same to predict the current chroma block. To this end, the encoder and decoder may store all pieces of LM encoding information for the corresponding chroma block in the reference picture.

CIIP is a method of predicting the current block by performing both intra-prediction and inter-prediction for the current block and then performing weighted averaging of the prediction blocks. In a CIIP mode, motion information for the current block is already included. Therefore, when the encoder and decoder derive the intra-prediction mode from the reference picture, the encoder and decoder may use the motion information of the current block. Here, when the intra-prediction mode of the chroma block derived from the reference picture is CCLM, MMLM, CCCM, or GLM mode, the encoder and decoder may predict the chroma block of the CIIP mode by using the chroma coding mode of the reference block. Here, the encoder and decoder may perform intra-prediction and inter-prediction only on the luma block. Specifically, the encoder and decoder may generate a prediction block of the luma block by performing weighted averaging of the intra-prediction block and the inter-prediction block, and may generate a prediction block of the chroma block by using only the chroma coding mode of the reference block. According to this operation, the processing speed for blocks encoded in the CIIP mode may be increased. This is because inter-prediction is not performed on chroma blocks. In addition, the encoder may not signal information related to the chroma coding mode for the blocks encoded in the CIIP mode. Specifically, when the current block is in the CIIP mode, the encoder may not include information related to the chroma coding mode in the bitstream. When the current block is in the CIIP mode, the decoder may not parse information related to the chroma coding mode. Here, when the current block is in the CIIP mode, the decoder may configure (or infer) the chroma coding mode of the current block to be a CCRM mode. In addition, the decoder may generate a chroma prediction block by using the CCRM method described herein.

Since the method of deriving parameters for a linear model uses only samples at promised positions, the accuracy of the linear model may differ depending on the accuracy of the samples. In the case of images captured by a camera, noise may occur in a predetermined pixel. When samples from positions where such noise occurs are used to derive parameters of a linear model, the accuracy of the linear model may be lowered. Embodiments for solving this problem will be described.

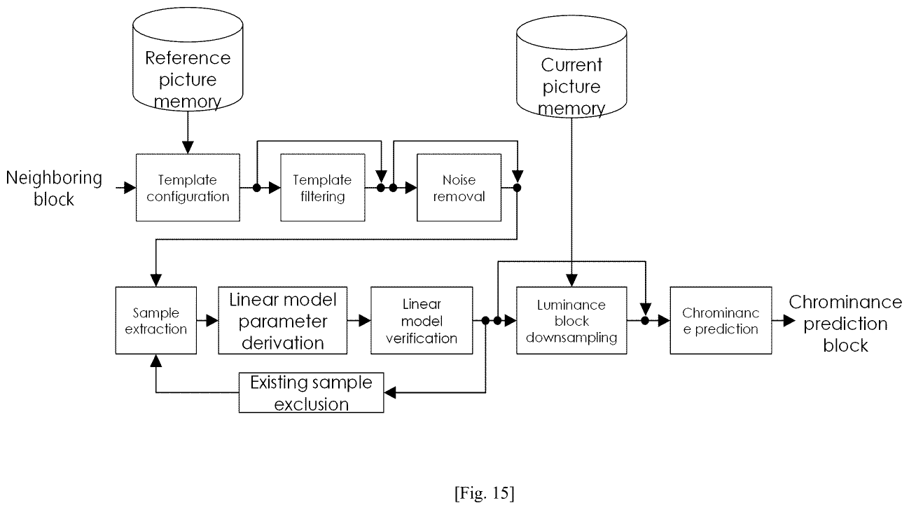

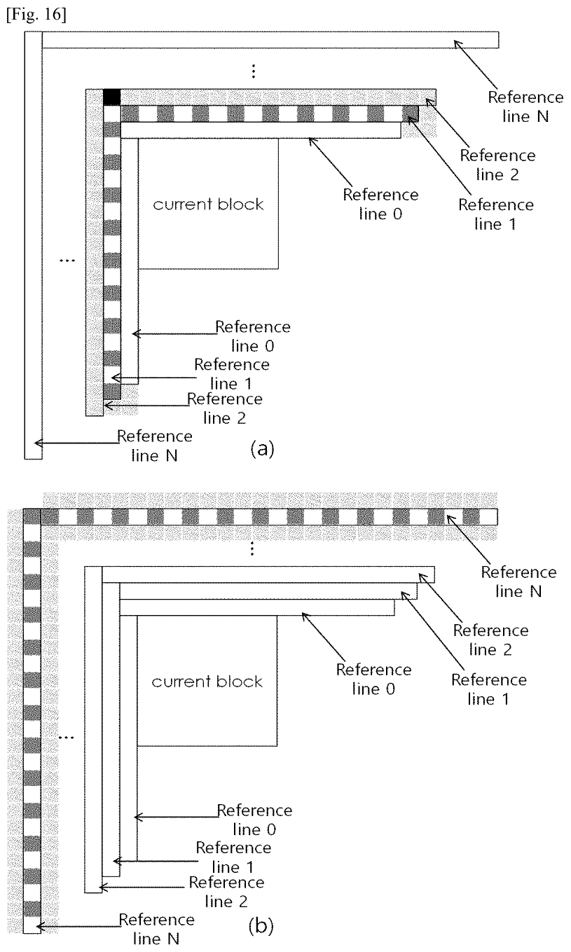

FIG. 15 illustrates a method for predicting a chroma block by using a recursive linear model according to an embodiment of the disclosure.

The encoder and decoder may configure a template for the embodiments described above and apply filtering between pixels within the template. Here, the encoder and decoder may perform low-frequency filtering. This operation may reduce the impact of noise within the template. In another specific embodiment, the encoder and decoder may perform high-frequency filtering and determine a pixel, in which a value difference between neighboring pixels is greater than a threshold, as noise. Here, the encoder and decoder may remove noise from the pixel determined as noise. Specifically, the encoder and decoder may replace a pixel determined as noise by one of the neighboring pixels or by a value obtained by weighted averaging the neighboring pixels. In these embodiments, the encoder and decoder may selectively apply template filtering. Whether or not template filtering is activated may differ in the picture, slice, or tile units. Specifically, when template filtering is activated in the picture unit, whether or not template filtering is applied may differ in the slice, tile, CU, and subblock units. The encoder may include, in the bitstream, information on whether filtering of the template is activated or not for each SPS unit, PPS unit, PH unit, slice unit, or tile unit. In addition, the encoder may include, in the bitstream, information on whether template filtering is applied for each CU unit or subblock unit. The decoder may parse information on whether template filtering is activated in any one of SPS, PPS, PH, slice, and tile units. When template filtering is activated, the decoder may parse information on whether filtering is applied in any one of CU and subblock units and determine whether to apply filtering to pixels in the template according to the information on whether filtering is applied.

As in the embodiment of FIG. 15, the encoder and decoder may compare and verify the parameters of the linear model acquired through the embodiments of applying filtering to pixels in the template described above with the parameters of the linear model acquired using samples of the existing template. Specifically, when a difference between the parameters of the linear model acquired through the embodiments of applying filtering to pixels in the template described above and the parameters of the linear model acquired using samples of the existing template is within a predesignated value, the encoder and decoder may determine that the linear model acquired by applying filtering is the final linear model. The predesignated value may be an integer of 1 or greater. In another specific embodiment, when a ratio between the parameters of the linear model acquired through the embodiments of applying filtering to pixels in the template described above and the parameters of the linear model acquired using samples of the existing template is a predesignated ratio or greater, the encoder and decoder may determine that the linear model acquired by applying filtering is the final linear model. The predesignated ratio may be a value from 0 to 1. When the final linear model is not acquired, the encoder and decoder may derive the linear model again, excluding the samples used to acquire the linear model. The encoder and decoder may repeat this process until the final linear model is acquired. Here, this process may be repeated a predesignated number of times or less. In a specific embodiment, when the encoder and decoder fail to acquire the final linear model a predesignated number of times, the encoder and decoder may determine the last acquired linear model as the final linear model. The predesignated number of times may be an integer of 1 or greater. In another specific embodiment, the process may be repeated until the number of remaining samples, excluding those already used as templates, is within a predesignated number. In a specific embodiment, when the encoder and decoder fail to acquire the final linear model until the number of samples remaining, excluding those already used as templates, is within a predesignated number, the encoder and decoder may determine the last acquired linear model as the final linear model. The predesignated number may be 1 or more.

When the parameters of a linear model are derived using the CCLM or MMLM, the encoder and decoder use only a predesignated number of samples among the samples in the template. The predesignated number may be 4. The encoder and decoder may verify the parameters of a linear model by using parameters of the linear model acquired through the embodiments of applying filtering to pixels in the template among the embodiments described through the embodiment of FIG. 15 and samples in the template that were not used to derive the parameters of the linear model. Specifically, the encoder and the decoder may apply the linear model parameters obtained through the embodiments of applying filtering to pixels in the template described above to the luma samples of samples not used to derive the parameters of the linear model among the samples in the template, and then predict chroma samples corresponding to the luma samples. The encoder and decoder may verify the parameters of the linear model by comparing reconstructed chroma samples and chroma samples predicted through the linear model parameters. When the difference between the chroma sample predicted through the linear model parameter and the reconstructed chroma sample is within a predesignated value, the encoder and decoder may determine that the linear model acquired by applying filtering is the final linear model. The predesignated value may be an integer of 1 or greater. When the difference between the chroma sample predicted through the linear model parameter and the reconstructed chroma sample is greater than or equal to a predesignated value, the encoder and decoder may derive a linear model again from the samples in the template, excluding the sample used to acquire the linear model. The encoder and decoder may repeat this process until the final linear model is acquired. Here, linear model derivation may be repeated a predesignated number of times or less. In a specific embodiment, when the encoder and decoder fail to acquire the final linear model a predesignated number of times, the encoder and decoder may acquire, as the final linear model, a linear model having the smallest difference between the chroma sample predicted through the linear model parameters and the reconstructed chroma sample. The predesignated number of times may be an integer of 1 or greater. In another specific embodiment, the process may be repeated until the number of samples in the template, excluding the samples used to derive the linear model, is within a predesignated number. In a specific embodiment, when the encoder and decoder fail to acquire the final linear model until the number of samples excluding samples already used as templates is within a predesignated number, the encoder and decoder may determine, as the final linear model, a linear model having the smallest difference between the chroma sample predicted through the linear model parameters and the reconstructed chroma sample. The predesignated number may be an integer of 1 or greater.

FIG. 16 illustrates a reference area used to generate a reference linear model according to an embodiment of the disclosure.

As in the embodiments described with reference to FIG. 9, Type 1 and Type 2 filters may be used to generate down-sampled luma samples. In FIG. 16, dark gray samples correspond to positions at which down-sampled luma samples are generated, and light gray samples represent neighboring pixels used to generate the luma samples at the dark gray position. These gray samples may be referred to as a gray reference area. The encoder and decoder may use multiple reference pixel lines to predict the current block. Here, the encoder may include, in the bitstream, a reference pixel line index indicating a reference pixel line to be used among several reference pixel lines. The decoder may determine the reference pixel line used to generate a prediction block for the current block by parsing the reference pixel line index from the bitstream. The reference area, in which the encoder and decoder derive a linear model for generating a chroma prediction block according to the reference pixel line, may differ. When the reference pixel line used by the encoder and decoder to generate a prediction block for the current block is adjacent to the current block, the decoder may use the gray reference area as shown in (a) of FIG. 16 to derive a linear model for generating the chroma prediction block. The reference pixel line is adjacent to the current block in case that the reference pixel line has a value smaller than a predesignated value. The predesignated value may be an integer of 1 or greater. For example, the predesignated value may be 2. When the reference pixel line used by the encoder and decoder to generate a prediction block for the current block is not adjacent to the current block, the decoder may use the gray reference area, as shown in (b) of FIG. 16, to derive a linear model for generating a chroma prediction block. When the reference pixel line is not adjacent to the current block, the reference pixel line may have a value larger than a predesignated value. The predesignated value may be an integer of 1 or greater. For example, the predesignated value may be 1.

When the encoder and decoder apply a multi-CCP model such as MMLM and MM-CCCM, the encoder and decoder derive two linear models to predict chroma blocks. When the reference pixel line used by the encoder and decoder to generate a prediction block for the current block is not adjacent to the current block, for example, if the reference pixel line index has a value greater than 1, the encoder and decoder may use both the gray reference area in (a) of FIG. 16 and the gray reference area in (b) of FIG. 16 to derive two linear models for generating a chroma prediction block. The encoder and decoder may derive one linear model in the gray reference area of (a) of FIG. 16 and another linear model in the gray reference area of (b) of FIG. 16, and then may use the two derived linear models to generate prediction blocks for chroma blocks.

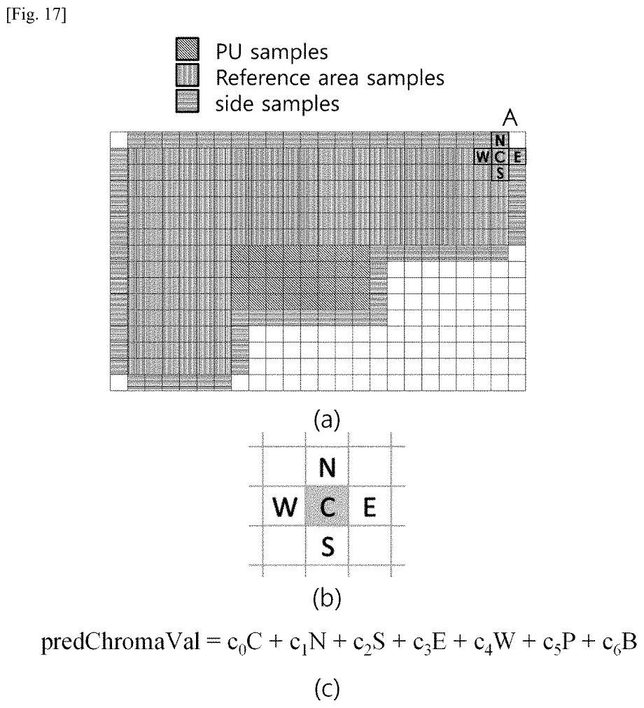

FIG. 17 illustrates reference samples and a mathematical expression used in the CCCM according to an embodiment of the disclosure.

The closer a linear model or non-linear model used to generate a prediction block for a chroma block is to the current block, the better it may express the characteristics of the current block. Therefore, the closer the linear model or non-linear model is to the current block, the more effective a model may be derived. If the reference pixel line used to generate the luma prediction block for the current block is not a reference pixel adjacent to the current block and is further away from the current block, the more likely it is that the area adjacent to the current block contains noise. This noise may prevent an effective linear model from being derived. Therefore, the decoder may determine whether to use a chroma prediction method based on CCP models, such as CCLM, MMLM, GLM, and CCCM, depending on the position of the reference pixel line used to generate the luma prediction block for the current block. When the reference pixel line index used to generate the luma prediction block for the current block has a value greater than a predesignated value, the decoder may not use a chroma prediction method based on CCP models, such as CCLM, MMLM, GLM, and CCCM. Here, the decoder may infer that the chroma prediction method based on CCP models, such as CCLM, MMLM, GLM, and CCCM is not used without parsing the syntax element related to CCP models such as CCLM, MMLM, GLM, and CCCM. The predesignated value may be an integer of 1 or greater. For example, the predesignated value may be 3.

(a) of FIG. 17 illustrates the positions of reference samples (vertical hatching) for applying the CCCM to the current prediction block (diagonal hatching samples) and side samples (horizontal hatching) required when applying a cross-shaped filter. The current prediction block ((W)×N(H)) may be configured by reference samples of six rows on the top side (2M×6), reference samples of six rows on the left side (6×2N), and reference samples on the top-left side (6×6), with the ratio of the number of chroma samples to the number of luma samples being 1:1. When the cross-shaped sample filter in (b) of FIG. 17 is applied to the chroma sample prediction relational expression in (c) of FIG. 17, the side samples (horizontal hatching) may fall outside the reference sample area. Here, an additional sample required may be a side sample. (c) of FIG. 17 may be performed for each chroma component. Chroma components may be Cb or Cr. The sample at the center (C) position may be a luma sample corresponding to the Cb or Cr chroma sample, and north (N), cast (E), south(S), and west (W) may be luma samples adjacent to the luma sample at the C position. Depending on the position of the C sample, one sample needs to be added to the side sample with respect to areas other than the reference sample. The encoder and decoder may perform padding with C-sample values if sample values are not available at the side sample positions. Specifically, referring to part A of (a) of FIG. 17, in order to calculate (c) of FIG. 17 for the sample at the top-right position in the reference sample area, the cross-shaped sample filter of (b) of FIG. 17 may be applied to the top-right position of the reference sample. Here, samples at the center (C), south(S), and west (W) are within the reference sample area, and thus sample values exist. However, since the samples at the north (N) and east (E) positions are outside the reference sample area, there are no sample values. Therefore, the encoder and decoder may be configured by padding samples at the north (N) and east (E) positions with C-sample values. In (c) of FIG. 17, the P value is a nonlinear value (nonlinear term) and may be defined as follows.

P=(C*C+midVal)>>bitDepth, in case of 10-bit content, P=(C*C+512)>>10.

In (c) of FIG. 17, B is a bias term and may be an integer offset value that is the median value of a bit-depth of content. When the bit-depth of the content is 10 bits, B may be 512. In (c) of FIG. 17, seven coefficients may be configured based on the luma and chroma samples of the reference sample area. Here, the encoder and decoder may calculate seven coefficients to minimize the mean square error (MSE) value of an autocorrelation matrix for the luma input value and a cross-correlation vector for the luma input value and the chroma output value. The encoder and decoder may acquire the autocorrelation matrix by using LDL decomposition. In another specific embodiment, the encoder and decoder may acquire the autocorrelation matrix by using Cholesky decomposition. In addition, the encoder and decoder may acquire seven coefficients by using back-substitution.

In (c) of FIG. 17, the B value may be defined as follows and one of them may be applied.

1. The average value of each chroma component

2. The difference between the average value of the luma samples of the entire reference sample and the average value of each chroma component, or the difference in absolute values

In the chroma sample prediction relational expression in (c) of FIG. 17, P, which is a nonlinear term, may be used as is or may be used according to the following mathematical expression.

1. P=(Cg*Cg+midVal)>>bitDepth: Cg may be a gradient value at the position C in (b) of FIG. 17. midVal may be the median value of bit-depth (bitDepth). In content with a bit-depth of 10 bits, the midVal may be 512.

2. Alternatively, the value of P may be the average value of the gradient values of the reference sample.

3. Alternatively, the value of P may be the average value of the gradient values at the positions in (b) of FIG. 17.

4. Alternatively, P=(meanG*meanG+bitDepth>>1)>>bitdepth. meanG may be the average value of gradient values of reference samples.

In addition, C, N, S, E, W, and P in (c) of FIG. 17 may be changed as follows. C′=C-mean Y, N′=N-meanY, S′=S-meanY, E′=E-meanY, W′=W-meanY, P′=P-meanNonlinY, and mean Y may be the average value of the lumas in the reference sample area. meanNonlinY may be configured such that

$$meanNonlinY = ( meanY * meanY ) >> \text{bitdepth.}$$

Alternatively, meanNonlinY may be configured such that meanNonlinY=(meanY*mean Y+bitdepth>>1)>>bitdepth.

To calculate mean Y and meanChroma, the encoder and decoder may only use samples at specific positions.

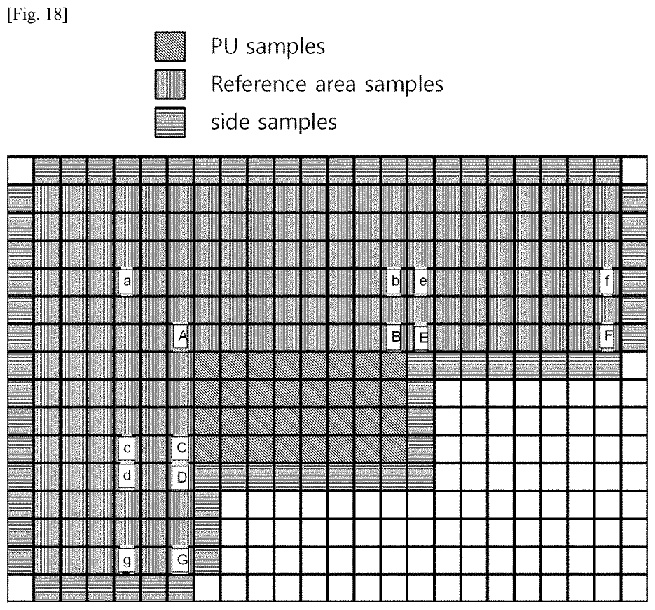

FIG. 18 illustrates a differential sample-based CCCM method according to an embodiment of the disclosure.

The encoder and decoder may calculate meanY and meanChroma values using at least one sample at positions A, B, C, D, E, F, G, a, b, c, d, e, f, and g in FIG. 18. In addition, the sample position to search may differ depending on the shape of template used in the CCCM. For example, the template used in the CCCM may be not only the template in (a) of FIG. 17, but also a top template using only the top pixels of the current block and a top template using only the left pixels of the current block. Here, the top template may be used at the time of applying the CCCM to the current block. In this case, the encoder and decoder may calculate mean Y and meanChroma values by using at least one sample at the positions B, E, F, b, c, and f within the top template.

Based on the changed C′, N′, S′, W′, and P′, (c) of FIG. 17 may be changed as shown in Equation 7 below. Unlike (c) of FIG. 17, the average value of each chroma component may be added to Equation 7.

$$predChromaVal = c 0 C ’ + c 1 N ’ + c 2 S ’ + c 3 E ’ + c 4 W ’ + c 5 P ’ + c 6 B ’ + meanChroma \qquad Equation 7$$

meanChroma may be the average value for each of the chroma samples (Cb, Cr) of the reference sample area.

In Equation 7, B′ may be defined as the difference between the average value of the luma sample in the reference sample and the average value for each chroma component, or the difference in absolute values.

Excluding B′ in Equation 7, it may be defined as follows.

$$predChromaVal = c 0 C ’ + c 1 N ’ + c 2 S ’ + c 3 E ’ + c 4 W ’ + c 5 P ’ + meanChroma \qquad Equation 8$$

The coefficient of the luma sample that may be used in Equation 8 may be acquired from a combination of five luma position samples. The number of coefficients required may also differ depending on the number of lumas used in a specific embodiment. In addition, in Equation 8, luma samples of a predesignated number and predesignated positions may be used.

The luma samples (C, N, E, S, W) required in (c) of FIG. 17 and the luma samples (C′, N′, E′, S′, W′) required in Equation 7 may be replaced by different values. The relational expression of (c) of FIG. 17 or the mathematical expression 7, which can be used in the CCCM, may be used as is or partially modified, but may be replaced by a gradient value instead of a value expressed as a luma sample value or a modified luma sample value.

In the CCCM, the autocorrelation matrix may be calculated using the reconstructed values of the luma and chroma samples. Since these samples are in the full range (from 0 to 1023 in case of 10-bit content), the value of the autocorrelation matrix is relatively large. To this end, a calculation process at a deep bit-depth is required during the calculation of model parameters. A method of differentiating the meanY and meanNonlinY values may be a method of solving this problem. However, the method of differentiating an average value requires an additional pipeline operation because the average value should be calculated. This ultimately increases the complexity of the implementation. To mitigate this drawback, predesignated values of the luma sample and the chroma sample may be differentiated for each model. Specifically, the value obtained by subtracting an offset value from the luma sample value and the chroma sample value input to each model may be used as the input value of the luma sample and the input value of the chroma sample, respectively. This reduces the size of the values used to generate the model and reduces the precision required for fixed-point operations. In addition, the CCCM implementation uses 16-bit floating-point precision instead of 22-bit precision. These embodiments are described with reference to FIG. 18.

FIG. 18 illustrates an offset differential sample-based CCCM according to an embodiment of the disclosure.

The offset value described above may be the value of a luma sample at a predesignated position among neighboring samples of the current block. In FIG. 18, the pixel value at position A is used as offsets (offsetLuma, offsetCb, and offsetCr) for simplicity. Specifically, the encoder and decoder may use the luma sample value from the pixel value at position A as offsetLuma, the Cb chroma sample value from the pixel value at position A as offsetCb, and the Cr chroma sample value from the pixel value at position A as offsetCr. The sample values used for model generation and final prediction (i.e., luma and chroma of the reference area, luma of the current PU) may be reduced by a fixed value as follows.

$$\begin{matrix}C ’ = C - offsetLuma \\ N ’ = N - offsetLuma \\ S ’ = S - offsetLuma \\ E ’ = E - offsetLuma \\ W ’ = W - offsetLuma \\ P ’ = nonLinear ( C ’ ) \\ B = midValue = 1 << ( bitDepth - 1 )\end{matrix}$$

The chroma value is predicted using the following Equation 9, where offsetChroma may be used as the offsetCr and offsetCb values for the Cr and Cb components, respectively.

$$predChromaVal = c 0 C ’ + c 1 N ’ + c 2 S ’ + c 3 E ’ + c 4 W ’ + c 5 P ’ + c 6 B + offsetChroma \qquad Equation 9$$

Here, when the luma sample value at position A in FIG. 18, which is used as the offsetLuma value, is 0, a differentiation process is not performed. Therefore, the calculation may need to be performed again at the existing deep bit-depth. To solve this problem, various methods may be applied as follows.

When the luma sample value at the predesignated position used as the offsetLuma value, for example, position A in FIG. 18, does not fall within the predesignated range, the encoder and decoder may use the predesignated default offset values as offsetLuma, offsetCr, and offsetCh values. The predesignated first value and the predesignated second value may be integers of 1 or greater. In addition, the predesignated first value and the predesignated second value may differ depending on the bit-depth used to represent the current sample. When the bit-depth is 10 bits, the predesignated first value may be any one of 0, 128, 256, 512, 768, and 1023, and the second value may be a value greater than the first value among the remaining values. The predesignated default offsetLuma, offsetCr, and offsetCb values may be integers. In another specific embodiment, when the bit-depth is 10 bits, the first predesignated value may be any one of −256, −128, 0, 128, and 256, and the second value is a value greater than the first value among the remaining values.

In another embodiment, when the luma sample value at a position predesignated by the offsetLuma value, e.g., position A in FIG. 18, does not fall within the predesignated range, the encoder and decoder may search for samples of pre-designated additional candidate positions, e.g., positions B, C, D, E, F, G, a, b, c, d, e, f, and g in FIG. 18, in sequence, and may determine whether the value of the luma sample at the corresponding position is valid as an offset value. Here, when the luma sample value falls within a predesignated range, the encoder and decoder may determine that the luma sample value at the corresponding position is valid as an offset value. The encoder and decoder may use the luma sample value that is initially determined to be valid or the value of the chroma sample corresponding to the luma sample as offset values, such as offsetLuma, offsetCr, and offsetCb. Specifically, the encoder and decoder may use the luma sample value initially determined to be valid as offsetLuma, the value of the Cr chroma sample corresponding to the luma sample determined to be valid as offsetCr, and the value of the Cb chroma sample as offsetCb.

In another embodiment, it may be determined whether the luma sample value at the corresponding position is a valid offset value while samples at a plurality of predesignated positions, such as the positions A, B, C, D, E, F, G, a, b, c, d, e, f, and g in FIG. 18 are retrieved in sequence. The encoder may include, in the bitstream, offset sample information indicating the most optimal sample position after applying the CCCM using the values of all valid luma samples. The decoder may parse the offset sample information from the bitstream and then use the luma sample value corresponding to the offset sample information as the offset value.

In another embodiment, when the luma sample value at a predesignated position, e.g., position A in FIG. 18, which is used as the offsetLuma value, does not fall within a predesignated range, the encoder may not use the CCCM to encode the current chroma block. Here, the encoder may not include information related to the CCCM in the bitstream. When the luma sample value at a predesignated position does not fall within the predesignated range, the decoder may not parse information related to the CCCM. Here, the decoder may infer that all of syntax elements related to the CCCM have a value of 0. In another specific embodiment, the decoder may be configured not to use a syntax element related to the CCCM.

In another embodiment, when the values of all the luma samples at candidate positions of luma samples that may be used as offset values, for example, positions A, B, C, D, E, F, G, a, b, c, d, e, f, and g in FIG. 18 do not fall within a predesignated range, the encoder may not use the CCCM to encode the current chroma block. Here, the encoder may not include information related to the CCCM in the bitstream. When the values of all luma samples at candidate positions of luma samples that may be used as offset values do not fall within a predesignated range, the decoder may not parse information related to the CCCM. Here, the decoder may infer that all of syntax elements related to the CCCM have a value of 0. In another specific embodiment, the decoder may be configured not to use a syntax element related to the CCCM.

In the embodiments described above, a case in which the value of the luma sample at a predesignated position does not fall within a predesignated range may correspond to a case in which the value is less than a predesignated first value or greater than a predesignated second value. The predesignated second value may be determined according to a bit-depth used to represent the current sample. When the bit-depth is 10 bits, the predesignated second value may be one of 768 and 1023. In addition, the predesignated first value may be one of 128 and 256.

In the embodiments described above, a candidate position of a luma sample that may be used as an offset value may be determined according to the type of template used in the CCCM. For example, the template used in the CCCM may be not only the template in (a) of FIG. 17, but also a top template using only the top pixels of the current block and a top template using only the left pixels of the current block. Here, when the top template is used at the time of applying the CCCM to the current block, the encoder and decoder may sequentially search for samples at sample positions B, E, F, b, c, and f within the top template and inspect whether the samples at the corresponding positions are samples within a valid range. When the sample at the corresponding position is valid, the encoder and decoder may use the luma sample value at the corresponding position as offsetLuma and the chroma sample values at the corresponding position as offsetCr and offsetCb.

In the embodiments described above, when the encoder and decoder determine whether the value of the luma sample falls within a predesignated range, the encoder and decoder may configure a predesignated range by using at least one of the minimum value, median value, maximum value, and average value of neighboring samples adjacent to the current block.

In FIG. 18, when the pixel value at position A is smaller than the predesignated first value or greater than the predesignated second value, the encoder may not use at least one of the CCLM, MMLM, GLM, and CCCM used to encode the current chroma block. In addition, the encoder may not include at least one piece of information related to the CCLM, MMLM, GLM, and CCCM in the bitstream. In FIG. 18, when the pixel value at position A is smaller than a predesignated first value or greater than a predesignated second value, the decoder may not parse at least one piece of information related to the CCLM, MMLM, GLM, and CCCM. In addition, the decoder may infer that all of one or more syntax elements related to the CCLM, MMLM, GLM, and CCCM have a value of 0. In another specific embodiment, the decoder may be configured not to use one or more syntax elements related to the CCLM, MMLM, GLM, and CCCM.

When the encoder and decoder apply a multi-CCP model such as MMLM and MM-CCCM, the encoder and decoder may configure the average value of luma samples of neighboring blocks as the first threshold, and may derive two linear models through neighboring blocks based on the first threshold. Here, the encoder and decoder may compare the luma sample value of the current block with the first threshold to determine whether to derive a chroma sample corresponding to the luma sample by using one linear model or to derive a chroma sample corresponding to the luma sample by using two linear models. Specifically, when the difference between the luma sample of the current block and the first threshold is smaller than a predesignated value, the encoder and decoder may predict the chroma sample by using both two linear models. In addition, when the difference between the luma sample of the current block and the first threshold is equal to or greater than a predesignated value, the encoder and decoder may predict the chroma sample by using one linear model.

The encoder and decoder may compare the luma sample of the current block, the predetermined number of luma samples around the luma sample of the current block, and both the luma sample of the current block and the predetermined number of luma samples around the luma sample of the current block with a first threshold to predict a chroma sample corresponding to the luma sample of the current block by using at least one of the number of samples belonging to the first linear model and the second linear model, the difference between the luma sample of the current block and the first threshold, the first linear model, the second linear model, the weight for the first linear model, and the weight for the second linear model. Here, the first linear model and the second linear model are linear models derived using the first threshold. In the following description, a sample belonging to a model may refer to a sample used to derive the model. Here, through the method of determining whether the luma sample belongs to the first linear model and the second linear model, the luma sample may be determined to belong to the first linear model if the luma sample has a value equal to or less than the first threshold, and the luma sample may be determined to belong to the second linear model if the luma sample has a value greater than the first threshold.

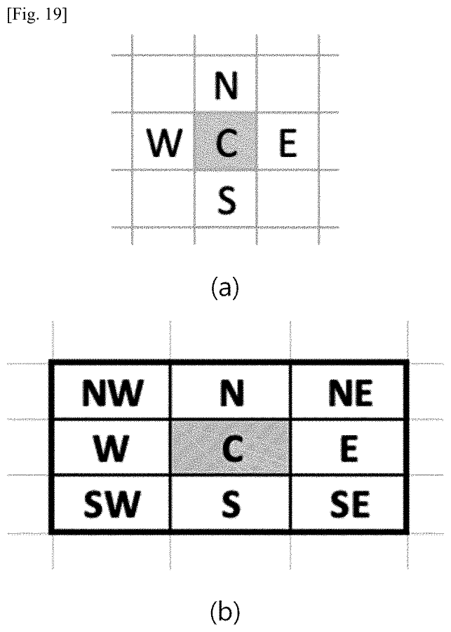

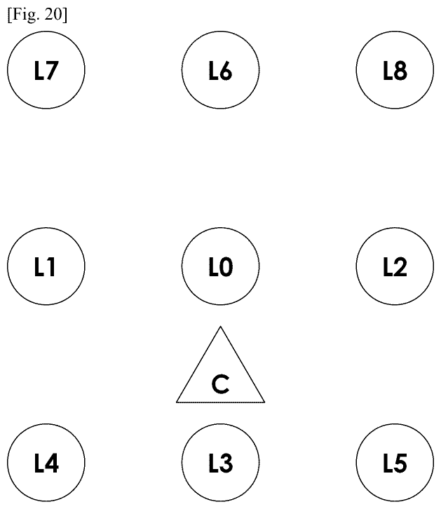

FIG. 19 illustrates a predesignated number of neighboring luma samples around the current block that are considered for derivation of a model used for chroma sample prediction according to an embodiment of the disclosure.

(a) of FIG. 19 illustrates four luma samples around the current block, and (b) of FIG. 19 illustrates eight luma samples around the current block. The encoder and decoder calculate the number of luma samples belonging to a first linear model and a second linear model by comparing the luma sample of the current block and a predesignated number of luma samples around the luma sample of the current block with a first threshold. Here, the encoder and decoder may determine a linear model to which the luma sample belongs by comparing the first threshold with the luma sample value at the position of the sample finally generated when a filter is applied to perform downsampling of the luma sample. When the number of luma samples belonging to the first linear model is equal to or greater than the predesignated first value, the encoder and decoder may predict the chroma samples corresponding to the luma samples of the current block by using only the first linear model. When the number of luma samples belonging to the second linear model is equal to or greater than the predesignated first value, the encoder and decoder may predict the chroma samples corresponding to the luma samples of the current block by using only the second linear model. Here, the predesignated first value may be an integer of 1 or greater, and may be 6. When the number of luma samples belonging to the first linear model is greater than the number of luma samples belonging to the second linear model, the encoder and decoder may configure a predesignated first weight in the first linear model and configure a predesignated second weight in the second linear model. Here, the encoder and the decoder may derive the first chroma sample by using the first linear model and the second chroma sample by using the second linear model, and then perform weighted averaging of the first chroma sample by using a first weight and the second chroma sample by using a second weight, so as to derive a chroma sample corresponding to the luma sample of the current block. Otherwise, that is, when the number of luma samples belonging to the first linear model is equal to or smaller than the number of luma samples belonging to the second linear model, the encoder and decoder configure the first weight in the second linear model, and configure the second weight in the first linear model. Here, the encoder and decoder may derive the first chroma sample by using the first linear model and the second chroma sample by using the second linear model, and then perform weighted averaging of the first chroma sample by using the second weight and the second chroma sample by using the first weight so as to finally derive a chroma sample corresponding to the luma sample of the current block. The encoder and decoder may construct a chroma prediction block by using the chroma samples. Here, the first weight and the second weight may be predesignated values. In addition, the first weight may be a larger value than the second weight. For example, the first weight may be 13. In addition, the second weight may be 3. Here, the weighted average between the sample values A and B may be calculated as (A*first weight+B*second weight)>>Shift. The value of the shift may be determined according to the first weight and the second weight. The value of the shift is the value obtained by converting the sum of the first weight and the second weight into a binary number and then subtracting 1 from N, which is the number of binary bits converted. For example, when the first weight is 13 and the second weight is 3, the sum of the weights is 16, which is converted into a binary number of 10000, the number of binary bits is 5, and the value of the shift is 4. Accordingly, when the sample values A and B are calculated as a weighted average, the weighted average value is reconstructed to the bit-depth of the sample value.

In another specific embodiment, the encoder and decoder may determine whether to use each of the first linear model or the second linear model, based on the difference between the luma sample of the current block and the first threshold, such as the average value of the luma samples of neighboring blocks, and the difference between the luma sample of the current block and the second threshold or the third threshold. Here, the encoder and decoder may derive the chroma sample by using only the first linear model or only the second linear model, or performing weighted averaging of the samples that derived the first linear model and the second linear model. When the difference between the luma sample of the current block and the first threshold, for example, the average value of luma samples of neighboring blocks, is greater than the second threshold, the luma sample of the current block is compared with the first threshold. When the luma sample of the current block is greater than the first threshold, the encoder and decoder may predict the chroma sample corresponding to the luma sample of the current block by using the second linear model. When the luma sample of the current block is equal to or less than the first threshold, the encoder and decoder may predict the chroma sample corresponding to the luma sample of the current block by using the first linear model. When the difference between the luma sample of the current block and the first threshold, such as the average value of luma samples of neighboring blocks, is equal to or less than the second threshold, and the difference between the luma sample of the current block and the first threshold is less than the third threshold, the encoder and decoder may configure a third weight in the first linear model and configure a fourth weight in the second linear model. Here, the encoder and decoder may derive a first chroma sample by using a first linear model and a second chroma sample by using a second linear model, and perform weighted averaging of the first chroma sample by using a third weight and the second chroma sample by using a fourth weight so as to finally derive a chroma sample corresponding to the luma sample of the current block. Here, the third weight and fourth weight may be predesignated values. For example, the third weight may be 1. Here, the fourth weight may be 1. When the difference between the luma sample of the current block and the first threshold is equal to or greater than the third threshold, the encoder and decoder may compare the luma sample of the current block and the first threshold. When the luma sample of the current block is equal to or less than the first threshold, the encoder and decoder may configure a first weight in the first linear model and configure a second weight in the second linear model. Here, the encoder and the decoder may derive a first chroma sample by using a first linear model and a second chroma sample by using a second linear model, and then perform weighted averaging of the first chroma sample by using a first weight and the second chroma sample by using a second weight so as to finally derive a chroma sample corresponding to the luma sample of the current block. When the luma sample of the current block is greater than the first threshold, the encoder and decoder may configure the first weight in the second linear model and configure the second weight in the first linear model, derive the first chroma sample by using the first linear model and the second chroma sample by using the second linear model, and then perform weighted averaging of the first chroma sample by using the second weight and the second chroma sample by using the first weight so as to finally derive a chroma sample corresponding to the luma sample of the current block. Here, the first weight and the second weight may be predesignated values. For example, the third weight may be 1. For example, the first weight may be 13. In addition, the second weight may be 3. The encoder and decoder may construct a chroma prediction block by using the chroma samples.

In another specific embodiment, the encoder and decoder may derive a chroma sample corresponding to the luma sample of the current block by using at least one of one linear model derived from neighboring blocks of the current block and two linear models derived based on the average value of neighboring blocks of the current block. Specifically, the encoder and the decoder may acquire the number of luma samples belonging to the first linear model and the second linear model by comparing a first threshold with each of a luma sample of the current block, a predesignated number of luma samples around the luma sample of the current block, and a luma sample of the current block and a predesignated number of luma samples around the luma sample of the current block. Here, the encoder and decoder may predict a chroma sample corresponding to the luma sample of the current block by using at least one of the number of luma samples belonging to the first linear model and the second linear model, the difference between the luma sample of the current block and the first threshold, the first linear model, the second linear model, the third linear model, the weight for the first linear model, the weight for the second linear model, and the weight for the third linear model. The first linear model and the second linear model are linear models derived using the first threshold. In addition, the third linear model is a linear model derived using all samples of neighboring blocks. The encoder and decoder may construct a chroma prediction block by using the chroma samples.

In a specific embodiment, the encoder and decoder may compare the luma sample of the current block, a predesignated number of luma samples around the luma sample of the current block, and (b) in the embodiment of FIG. 19 with a first threshold so as to calculate the number of luma samples belonging to the first linear model and the number of luma samples belonging to the second linear model. When the number of luma samples belonging to the first linear model is equal to or greater than the first predesignated value, the encoder and decoder may predict chroma samples corresponding to the luma samples of the current block by using only the first linear model. When the number of second linear models is equal to or greater than the first predesignated value, the encoder and decoder may predict chroma samples corresponding to the luma samples of the current block by using only the second linear model. Here, the first predesignated value may be 6. When the number of first linear models is greater than the number of second linear models, the encoder and decoder may configure a first weight in the first linear model and a second weight in the third linear model. Here, the encoder and decoder may derive the first chroma sample by using the first linear model and the second chroma sample by using the third linear model, and then perform weighted averaging of the first chroma sample by using the first weight and the second chroma sample by using the second weight so as to finally derive a chroma sample corresponding to the luma sample of the current block. When the number of luma samples belonging to the first linear model is equal to or smaller than the number of luma samples belonging to the second linear model, the encoder and decoder may configure the first weight in the second linear model and configure the second weight in the third linear model. Here, the encoder and decoder may derive a first chroma sample by using the second linear model and a second chroma sample by using the third linear model. Here, the encoder and decoder may perform weighted averaging of the first chroma sample by using the first weight and the second chroma sample by using the second weight so as to finally derive a chroma sample corresponding to the luma sample of the current block. Here, the first weight and the second weight may be predesignated values. For example, the first weight may be 13. In addition, the second weight may be 3. The encoder and decoder may construct a chroma prediction block by using the chroma samples.

In another specific embodiment, the encoder and decoder may determine whether to use each of the first linear model, the second linear model, and the third linear model, based on the difference between the luma sample of the current block and a first threshold, such as the average value of luma samples of neighboring blocks, the difference between the luma sample of the current block and the second threshold, or the difference between the luma sample of the current block and the third threshold. Here, when the encoder and decoder use multiple models, the encoder and decoder may derive chroma samples by performing weighted averaging of the multiple models. When the difference between the luma sample of the current block and the first threshold is greater than the second threshold, the encoder and decoder compare the luma sample of the current block and the first threshold. When the luma sample of the current block is greater than the first threshold, the encoder and decoder may predict the chroma sample corresponding to the luma sample of the current block by using the second linear model. When the luma sample of the current block is equal to or less than the first threshold, the encoder and decoder may predict the chroma sample corresponding to the luma sample of the current block by using the first linear model. When the difference between the luma sample of the current block and the first threshold is equal to or less than the second threshold and the difference between the luma sample of the current block and the first threshold is less than the third threshold, the encoder and decoder may configure a third weight in the first linear model, configure a fourth weight in the second linear model, and configure a fifth weight in the third linear model. Here, the encoder and the decoder may derive a first chroma sample by using the first linear model, a second chroma sample by using the second linear model, and a third chroma sample by using the third linear model. The encoder and decoder may perform weighted averaging of the first chroma sample by using the third weight, the second chroma sample by using the fourth weight, and the third chroma sample by using the fifth weight, so as to finally derive a chroma sample corresponding to the luma sample of the current block. Here, the third weight, fourth weight, and fifth weight may be predesignated values. For example, the third weight may be 1, and the fourth weight may be 1. In addition, the fifth weight may be 1. When the difference between the luma sample of the current block and the first threshold is equal to or greater than the third threshold, the encoder and decoder may compare the luma sample of the current block and the first threshold. When the luma sample of the current block is equal to or less than the first threshold, the encoder and decoder may configure a first weight in the first linear model and configure a second weight in the third linear model. The encoder and decoder may derive first chroma samples derived using the first linear model and second chroma samples derived using the third linear model. The encoder and decoder may perform weighted averaging of the first chroma sample by using the first weight and the second chroma sample by using the second weight, so as to finally derive a chroma sample corresponding to the luma sample of the current block. When the luma sample of the current block is greater than the first threshold, the encoder and decoder may configure a first weight in the second linear model and configure a second weight in the third linear model. Here, the encoder and decoder may derive first chroma samples using a second linear model, and may derive second chroma samples using a third linear model. The encoder and decoder may perform weighted averaging of the first chroma sample by using the first weight and the second chroma sample by using the second weight, so as to finally derive a chroma sample corresponding to the luma sample of the current block. The first weight and the second weight may be predesignated values. Here, the first weight may be 13. In addition, the second weight may be 3. The encoder and decoder may construct a chroma prediction block by using the chroma samples.

The encoder and decoder may derive chroma fusion (CF) by weighted averaging a chroma block (pred′C) predicted through a general intra-prediction mode instead of using an LM mode and the current luma block (rec′L), as shown in Equation 10. Here, the weighting parameters (a0, a1, a2) may be derived using the CCCM method. The midValue may be calculated as 1<<(bitDepth−1). In addition, the encoder may include information indicating whether to use one CCCM model or two CCCM models in the bitstream. When the current chroma block is encoded in a CF mode, the decoder may parse information about the number of CCCM models to be used from the bitstream and predict the current chroma block based on the parsed information.

$$pred ( i , j ) = {α}_{0} \cdot {rec}_{L}^{′} ( i , j ) + {α}_{1} \cdot {pred}_{C}^{′} ( i , j ) + {α}_{2} \cdot midValue \qquad Equation 10$$

A gradient and location based convolutional cross-component model (GL-CCCM) is an additional CCCM mode using gradient and location information. The existing CCCM mode may derive a chroma sample for the current block by using a luma sample at a position corresponding to the chroma sample position to be predicted, four samples around the luma sample, (a) in the embodiment of FIG. 19, and coefficient information of a model (C0 to C6 in Equation 11). In the GL-CCCM mode, as shown in (b) of FIG. 19, the chroma sample for the current block may be derived by reflecting the vertical difference (Gy in Equation 11) and the horizontal difference (Gx in Equation 11) between the luma sample at a position corresponding to the chroma sample position to be predicted and the eight samples around the luma sample, and by using the position values of the current luma sample (X, Y in Equation 11) and its model coefficient information (C0 to C6 in Equation 11). Here, the position value of the current luma sample may be determined based on various references, including the top-left position of the reference template used to derive the CCCM model, the top-left position of the current block, the relative position of the current pixel when the top-left position of the current block is set as (0,0), and the recalculated value obtained through a predefined offset and a predefined shift value. Here, the position value of the current luma sample may be calculated (assuming that the top-left position of the current block is (0,0), the relative position value of the current pixel+the difference value between the top-left position of the reference template used to derive the CCCM model and the top-left position of the current block+the predesignated offset value)<<predesignated shift value). Here, the predesignated offset value may be an integer. For example, the predesignated offset value may be 8. In addition, the predesignated shift value may be an integer. For example, the predesignated shift value may be “3”. In addition, Gx and Gy may be calculated through Equation 12 using the sample in (b) of FIG. 19.

$$predChromaVal = {c}_{0} C + \underline{{c}_{1} {G}_{y} + {c}_{2} {G}_{x} + {c}_{3} Y + {c}_{4} X} + {c}_{5} P + {c}_{6} B \qquad Equation 11$$

$$\begin{matrix}{G}_{y} = ( 2 N + N W + N E ) - ( 2 S + S W + S E ) \\ {G}_{x} = ( 2 W + N W + S W ) - ( 2 E + NE + SE )\end{matrix} \qquad Equation 12$$

Model coefficient information, that is, weight parameter information may be derived using a predesignated area of already reconstructed neighboring blocks around the current block. The model coefficient information may be derived from the reference sample area using LDL decomposition as described in FIG. 17. Here, (b) of FIG. 17 may be changed and applied as (b) of FIG. 19, and (c) of FIG. 17 may be changed and applied as Equation 11. In addition, the encoder may include, in the bitstream, a flag indicating information on whether the GL-CCCM has been used in the current block. The decoder may parse the corresponding flag from the bitstream and determine whether to predict the chroma block by applying the GL-CCCM to the current block.

In the GL-CCCM, the luma samples used to calculate the vertical and horizontal differences between the luma samples may use not only samples around the current luma sample but also luma samples separated by a predesignated difference. Here, the predesignated difference may be 1 in FIG. 19, and may have values of 2, 3, and 4 in other cases.

The LM mode, which predicts the current chroma block by using the reconstructed current luma block, may match the resolution of the luma block to that of the chroma block by applying a down-sampling filter to the luma block due to the difference in resolution between the luma and chroma blocks. there is. Due to this down-sampling, the edge component information of the luma block may be reduced. Accordingly, the encoder and decoder may predict the chroma block by using samples of the luma block without downsampling the samples of the luma block. Specifically, the encoder and decoder may predict the chroma block by using samples of the luma block before downsampling.

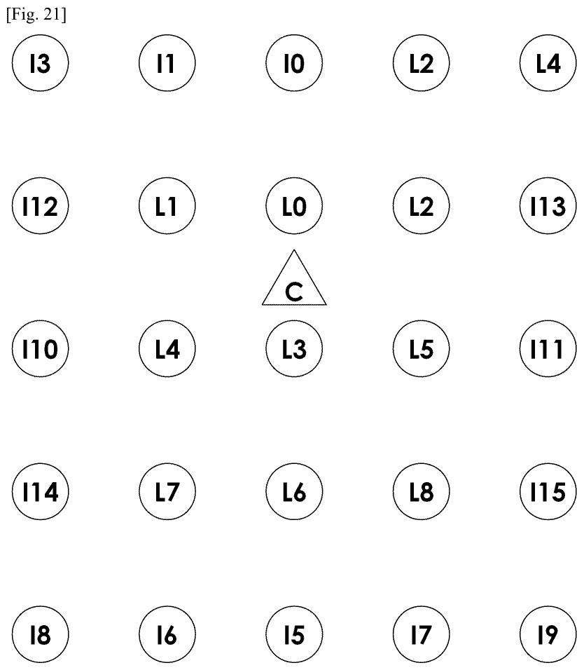

FIGS. 20 and 21 show luma samples before downsampling used to derive chroma samples in a CCCM-ND mode according to an embodiment of the disclosure.

CCCM using non-down-sampled luma samples (CCCM-ND) mode is a method of predicting a chroma block by using samples of the luma block before downsampling, instead of downsampling the samples of the luma block. FIG. 20 illustrates a chroma sample position C to be predicted and six luma sample positions corresponding to the chroma sample position. Here, the luma samples are samples before downsampling. Chroma samples are calculated using Equation 13, and may be calculated using six luma samples, a linear model using L0, L1, L2, L3, L4, and L5 samples in FIG. 20 and four luma samples, and a nonlinear model using L0, L3, L2, and L1 samples in FIG. 20. In Equation 13, offsetLuma and offsetchroma have the same meaning as the difference values described in the specification. B may be calculated as 1<<(bitDepth−1). LDL decomposition used in the CCCM may be used to derive the coefficients (a0 to a10).

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 6} - offsetLuma )}^{2} + β ) >> bitDepth ) + {α}_{10} \cdot β + offsetChroma \qquad Equation 13$$

The encoder may include, in the bitstream, a flag indicating whether the CCCM-ND has been applied to the current block. The decoder may determine whether the CCCM-ND is applied to the current block by parsing the corresponding flag from the bitstream. When the CCCM-ND is applied to the current block, the encoder may not include information about the GL-CCCM in the bitstream. When the CCCM-ND is applied to the current block, the decoder may not parse the information related to the GL-CCCM. In addition, the decoder may determine that the GL-CCCM is not applied to the current block.

The encoder and decoder may use downsampled luma samples from the GL-CCCM to derive a model, and use the downsampled luma samples of the current block to predict chroma samples for the current block. Here, in the GL-CCCM, like the CCCM-ND, luma samples before downsampling may be used to derive a model or be used to predict chroma samples.

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 6} - offsetLuma )}^{2} + β ) >> bitDepth ) + {α}_{10} {G}_{y} + {a}_{11} {G}_{x} + {a}_{12} Y + {a}_{12} Y + {a}_{13} X + {α}_{14} \cdot β + offsetChroma \qquad Equation 13$$

The chroma samples are calculated through Equation 14, a chroma sample for the current block may be derived by reflecting 6 luma samples, a linear model using L0, L1, L2, L3, LA, L5 luma samples in FIGS. 20 and 4 luma samples, a nonlinear model using L0, L3, L2, L1 in FIG. 20, and the vertical difference (Gy in Equation 14) and the horizontal difference (Gx in Equation 14) between the luma sample at a position corresponding to the chroma sample position to be predicted and the samples (L1 to L8 luma samples in FIG. 20) around the corresponding luma sample, and by using the position values of the current luma sample (X, Y in Equation 14) and its model coefficient information. Here, the encoder and decoder may calculate Gx and Gy through Equation 15 by using the sample of FIG. 20. In Equation 14, offsetLuma and offsetchroma have the same meaning as the difference values described in the specification. B may be calculated as 1<<(bitDepth−1). To derive the coefficients (a0 to a14), the LDL decomposition method used in the CCCM may be used.

$$\begin{matrix}Equation 15 & \\ \begin{matrix}{G}_{y} = ( 2 L 6 + L 7 + L8 ) - ( 2 L 3 + L 4 + L 5 ) \\ {G}_{x} = ( 2 L 1 + L 7 + L 4 ) - ( 2 L 2 + L 8 + L 5 )\end{matrix} & I\end{matrix}$$

In another specific embodiment, the luma samples of FIG. 21 may be used instead of the luma samples of FIG. 20, and the luma samples of L6, L7, and L8, which are samples below the current chroma sample, may be used.

The luma samples used in the CCCM-ND may be used not only samples around the luma sample corresponding to the current chroma sample, but also neighboring luma samples separated by a predesignated difference. Here, as shown in FIG. 21, the encoder and decoder may use L0 to L8 when the predesignated position is 1, and when the predesignated position is 2, the encoder and decoder may predict the chroma sample by using at least one of the luma samples L0 to L8 and 10 to 115.

When a chroma block is predicted using the luma block of the current block, the encoder and decoder may selectively apply the GL-CCCM and the CCCM-ND. Specifically, when the encoder and decoder predict chroma blocks, the encoder and decoder may select one of a mode to predict chroma blocks using the GL-CCCM, a mode to predict chroma blocks using the CCCM-ND, and a mode to predict chroma blocks using both the GL-CCCM and the CCCM-ND.

When a chroma block is predicted using the luma block of the current block, when the chroma block is predicted using only the GL-CCCM, the encoder may configure the value of a flag indicating whether to use the CCCM-ND as 0 and configure the value of a flag indicating whether to use the GL-CCCM as 1, and may include the two flags in the bitstream. The decoder may parse the two flags from the bitstream and determine to predict the chroma block of the current block by using only the GL-CCCM in a mode used to predict the chroma block based on the two flags.

When a chroma block is predicted using the luma block of the current block, if a mode for predicting a chroma block by using only the CCCM-ND is applied, the encoder may configure the value of the flag indicating whether to use the CCCM-ND as 1 and configure the value of the flag indicating whether to use the GL-CCCM as 0, and may include the two flags in the bitstream. The decoder may parse two flags from the bitstream and determine to predict the chroma block of the current block by using only the CCCM-ND in a mode used to predict the chroma block based on the parsed two flags.

When a chroma block is predicted using the luma block of the current block, if a mode for predicting a chroma block by using both the GL-CCCM and CCCM-ND is applied, the value of the flag indicating whether to use the CCCM-ND may be configured as 1 and the value of the flag indicating whether to use the GL-CCCM may be configured as 1, and the two flags may be included in the bitstream. The decoder may parse two flags from the bitstream and determine to predict the chroma block of the current block by using both the GL-CCCM and CCCM-ND in a mode used to predict the chroma block based on the parsed two flags.

The CCCM is a method of deriving linear and non-linear models using the correlation between luma samples and chroma samples of neighboring blocks adjacent to the current block, and then predicting chroma samples of the current block by using the reconstructed luma samples of the current block.

Embodiments that may be applied to the method using the correlation between these two signals will be described.

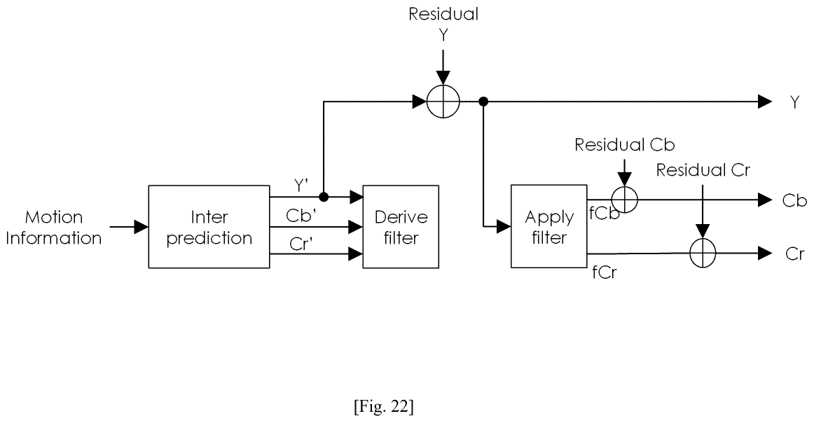

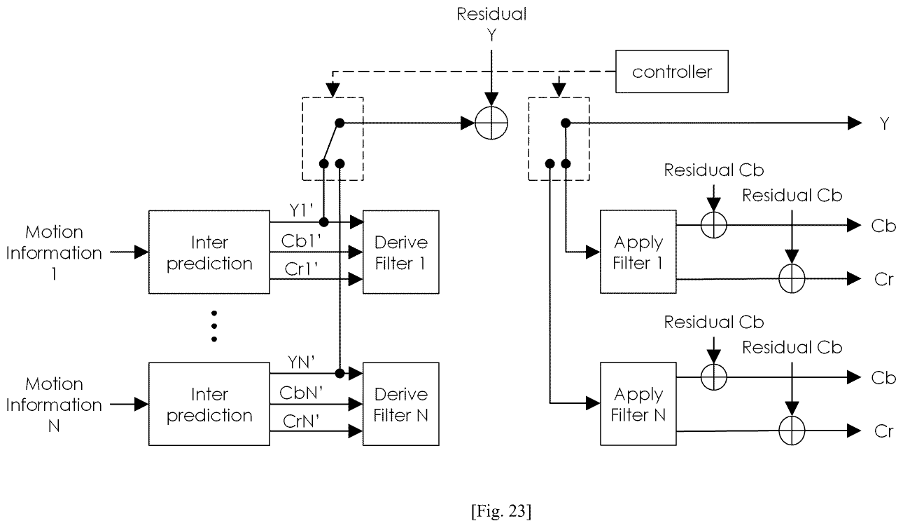

FIGS. 22 and 23 show a block diagram of a cross-component residual model (CCRM) according to an embodiment of the disclosure.

As shown in FIG. 22, when the inter-coding mode is applied to the current block, the encoder and decoder may generate a luma prediction block (Y′) of the current block and first chroma prediction blocks (Cb′, Cr′) of the current block by using the motion information of the current block, and acquire a CCP model between the luma prediction block (Y′) of the current block and the first chroma prediction blocks (Cb′, Cr′) of the current block. The encoder and decoder may generate a reconstructed luma block of the current block by using the luma error block of the current block. The encoder and decoder may apply the derived CCP model to the reconstructed luma block of the current block to generate second chroma prediction blocks (fCb, fCr) of the current block. The encoder and decoder may add a chroma error block to the second chroma prediction block of the current block predicted using the CCP model to finally generate chroma blocks (Cb, Cr) of the current block. This is called cross-component residual model (CCRM). The CCRM may be modified in the following embodiments.

The encoder and decoder may generate chroma samples in units of samples by using the derived CCP model, and then acquire a chroma prediction block by using the chroma samples.

Specifically, as shown in FIG. 22, when the inter-coding mode is applied to the current block, the encoder and decoder may generate a luma prediction block (Y′) of the current block and first chroma prediction blocks (Cb′, Cr′) of the current block by using the motion information of the current block, and acquire a CCP model between the luma prediction block (Y′) of the current block and the first chroma prediction blocks (Cb′, Cr′) of the current block. The encoder and decoder may generate a reconstructed luma block of the current block by using the luma error block of the current block. The encoder and decoder may apply the derived CCP model to the reconstructed luma sample of the current block to generate a chroma prediction sample of the current block. The encoder and decoder may construct the second chroma prediction blocks (fCb, fCr) by using the second chroma prediction samples of the current block predicted using the CCP model, and add a chroma error block to the second chroma prediction blocks to finally generate chroma blocks of the current block.

In a specific embodiment, the encoder and decoder may generate a third chroma prediction block by performing weighted averaging between the second chroma prediction blocks (fCb, fCr) of the current block predicted using the CCP model in FIG. 22 and the first chroma prediction blocks (Cb′, Cr′) in FIG. 22. Here, the encoder and decoder may apply a first weight to the first chroma prediction block and a second weight to the second chroma prediction block. Here, the first weight and the second weight are predefined values and may be integers. In addition, the first weight may be a value smaller than the second weight. For example, the first weight may be 3. In addition, the second weight may be 13. For example, the first weight may be 1. In addition, the second weight may be 3. The encoder and decoder may add the chroma error block to the third chroma prediction block so as to finally generate chroma blocks (Cb, Cr) of the current block. The encoder may include information indicating optimal weight values of the first weight and the second weight in the bitstream. When the CCRM is applied to the current block, the decoder may parse information indicating the optimal weight values of the first weight and the second weight and generate a chroma prediction block of the current block by using the parsed information.

The encoder and decoder may generate chroma samples in units of samples by using the derived CCP model, and then acquire a chroma prediction block by using the chroma samples. Here, the CCP model includes CCLM, MMLM, GLM, CCCM, MM-CCCM, GL-CCCM, CCCM-ND, and CCCM-MDF, wherein the CCLM and MMLM are linear models, and the GLM, CCCM, MM-CCCM, GL-CCCM, CCCM-ND, and CCCM-MDF may be nonlinear models. That is, the CCP model may be one CCP model among the CCLM, MMLM, GLM, CCCM, MM-CCCM, GL-CCCM, CCCM-ND, and CCCM-MDF.

In a specific embodiment, the encoder and decoder may generate a third chroma prediction block by performing weighted averaging between the second chroma prediction samples of the current block predicted using the CCP model in FIG. 22 and the first chroma prediction samples corresponding to the second chroma prediction samples in the first chroma prediction blocks (Cb′, Cr′) in FIG. 22. Here, when the second chroma prediction samples are samples at the top-left position of the current block, the first chroma prediction samples refer to samples at the top-left position in the first chroma prediction blocks (Cb′, Cr′) of FIG. 22. Here, the encoder and decoder may apply a first weight to the first chroma prediction sample and a second weight to the second chroma prediction sample. Here, the first weight and the second weight are predefined values and may be integers. In addition, the first weight may be a value smaller than the second weight. For example, the first weight may be 3. In addition, the second weight may be 13. For example, the first weight may be 1. In addition, the second weight may be 3. The encoder and decoder may construct a third chroma prediction block by using the third chroma prediction sample. The encoder and decoder may add the chroma error block to the third chroma prediction block so as to finally generate chroma blocks (Cb, Cr) of the current block. The encoder may include information indicating optimal weight values of the first weight and the second weight in the bitstream. When the CCRM is applied to the current block, the decoder may parse information indicating the optimal weight values of the first weight and the second weight and generate a chroma prediction block of the current block by using the parsed information.

In another specific embodiment, as shown in FIG. 23, when the current block is applied with an inter-coding mode, the encoder and decoder may derive one or more CCP models using motion information used to generate a prediction block for the current block, and may predict the chroma block of the current block by using one or more CCP models optionally. Here, the encoder may include, in the bitstream, information about a model to be used. The decoder may parse information about a model to be used and predict the chroma block of the current block by using the model indicated by the parsed information. Specifically, the current block is in an inter-coding mode, and bidirectional motion prediction may be applied to the current block. Here, the encoder and decoder may derive linear and non-linear models by using the predicted luma block and chroma block of the current block, wherein the weights of the predicted blocks are averaged by means of bidirectional motion. In another specific embodiment, the encoder and decoder may derive a CCP model by using the predicted luma block and chroma block of the current block generated through L0 motion. In another specific embodiment, the encoder and decoder may derive a CCP model by using the predicted luma block and chroma block of the current block generated through L1 motion. When bidirectional motion prediction is applied to the current block, the encoder may include, in the bitstream, information about the motion information used to derive the CCP model between L0 and L1. The decoder may parse information about the motion information used to derive the CCP model between L0 and L1, from the bitstream, and generate the chroma prediction block of the current block by using one of the CCP models derived through L0 and L1 using the parsed information. The encoder and decoder may add the chroma error block to the generated chroma prediction block so as to finally generate the chroma blocks (Cb, Cr) of the current block.

When the current block is in an inter-coding mode and bidirectional motion prediction is applied to the current block, the encoder and decoder may derive the first CCP model by using the first luma prediction block and the first chroma prediction block generated through L0 motion information. Here, the encoder and decoder may derive the second CCP model by using the second luma prediction block and the second chroma prediction block generated through L1 motion information. The encoder and decoder may generate a reconstructed luma block of the current block by using the luma error block of the current block. The encoder and decoder apply the derived first CCP model to the reconstructed luma block of the current block so as to generate a third chroma prediction block of the current block, and apply the derived second CCP model to the reconstructed luma block of the current block so as to generate a fourth chroma prediction block of the current block. The encoder and decoder may generate a weight-averaged fifth chroma prediction block by weighted averaging the first, second, third, and fourth chroma prediction blocks using the first, second, third, and fourth weights, respectively. Here, the first, second, third, and fourth weights are predefined values and may be integers. The encoder and decoder may add the chroma error block to the fifth chroma prediction block so as to finally generate chroma blocks (Cb, Cr) of the current block.

In the embodiments described with reference to FIG. 22, blocks (Y′, Ch′, Cr′) predicted using motion information of the current block are used to derive the CCP model. Here, the prediction block (Y′, Ch′, Cr′) may be a reference block for the current block. In order to improve the performance of the CCP model, the encoder and decoder may derive the CCP model by additionally using samples of neighboring blocks adjacent to the current block as well as reference blocks for the current block.

Specifically, when the inter-coding mode is applied to the current block, the encoder and decoder may derive a CCP model by using the first luma prediction sample and the first chroma prediction sample of neighboring blocks adjacent to the current block, and both the second luma prediction sample and the second chroma prediction sample of the reference block for the current block, acquired using the motion information of the current block. The encoder and decoder may generate a reconstructed luma block of the current block by adding the luma error block of the current block to the reference luma block for the current block. The encoder and decoder may apply the derived CCP model to the reconstructed luma block of the current block so as to generate a chroma prediction block of the current block. The encoder and decoder may add the chroma error block to the chroma prediction block of the current block predicted using the derived CCP model so as to finally generate the chroma block of the current block.

Specifically, when the inter-coding mode is applied to the current block, the encoder and decoder may derive a first CCP model by using the first luma prediction sample and the first chroma prediction sample of neighboring blocks adjacent to the current block. In addition, the encoder and decoder may derive a second CCP model by using the second luma prediction sample and the second chroma prediction sample of the reference block for the current block, acquired using the motion information of the current block. The encoder and decoder may generate a reconstructed luma block of the current block by adding the luma error block of the current block to a reference luma block for the current block. The encoder and decoder may apply the derived first CCP model to the reconstructed luma block of the current block so as to generate a third chroma prediction block of the current block. In addition, the encoder and decoder may generate a fourth chroma prediction block of the current block by applying the derived second CCP model to the reconstructed luma block of the current block. The encoder and decoder may generate a fifth chroma prediction block by weighted averaging the third chroma prediction block and the fourth chroma prediction block. The encoder and decoder may apply a first weight to the third chroma prediction block and a second weight to the fourth chroma prediction block. Here, the first weight and the second weight are predefined values and may be integers. In addition, the first weight may be a value smaller than the second weight. For example, the first weight may be 3. In addition, the second weight may be 13. For example, the first weight may be 1. In addition, the second weight may be 3. The encoder and decoder may add the chroma error block to the fifth chroma prediction block so as to finally generate the chroma block of the current block.

When the CCRM is applied, the encoder and decoder may derive linear and non-linear models by using any one of the methods of CCCM, GL-CCCM, CCCM-ND, and GLM described herein.

When the CCRM is applied to the reference block corresponding to the current block, the encoder and decoder do not derive a CCP model for the CCRM in the current block, but may apply the CCP model of the CCRM used in the reference block to the current block. In other words, the encoder and decoder may generate a chroma prediction block of the current block by applying the CCP model of the CCRM used in the reference block to the reconstructed luma block of the current block. Alternatively, the encoder and decoder may construct a CCP model list from reference blocks. Here, the encoder and decoder may rearrange the CCP model list, based on the template cost. The encoder may include, in the bitstream, index information of the optimal CCP model for the current block in the CCP model list. The decoder may parse the index information of the optimal CCP model from the bitstream and select the optimal CCP model for the current block from the CCP model list.

When any of the AMVP, merge, amvp-merge, IntraTMP, IBC, and merge-TM modes is applied to the current block, and an error signal exists in the luma block of the current block, the encoder may include, in the bitstream, information indicating whether to apply the CCRM to the current block. When an error signal exists in the luma block of the current block, the decoder may parse information indicating whether to apply the CCRM to the current block from the bitstream and determine whether to apply the CCRM to the current block, based on the parsed information.

When one of the coding modes among OBMC, MHP, LIC, DMVR, BDOF, PROF, BCW, Affine, GPM, CIIP, IBC-GPM, IBC-CIIP, and IBC-LIC is applied to the current block, the CCRM method may not be used for the current block. When one of the coding modes among OBMC, MHP, LIC, DMVR, BDOF, PROF, BCW, Affine, GPM, CIIP, IBC-GPM, IBC-CIIP, and IBC-LIC is applied to the current block, the encoder may not include information related to the CCRM in the bitstream for the current block. When one of the coding modes among OBMC, MHP, LIC, DMVR, BDOF, PROF, BCW, Affine, GPM, CIIP, IBC-GPM, IBC-CIIP, and IBC-LIC is applied to the current block, the decoder may not parse information related to the CCRM in the current block. Here, the encoder may determine that CCRM is not applied to the current block.

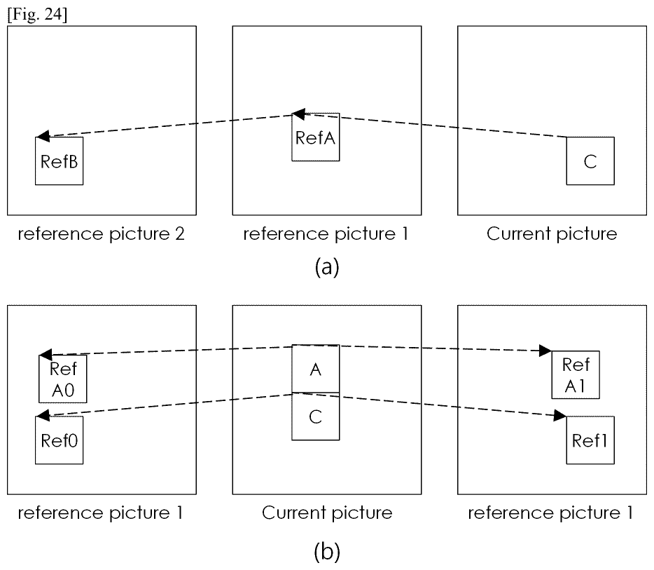

When the CCRM is performed, the correlation between a luma prediction block and a luma reconstruction block as well as the correlation between a luma prediction block and a chroma prediction block of the current block may be used. These embodiments are described with reference to FIG. 24.

FIG. 24 illustrates that the CCRM is performed using the correlation between a luma prediction block and a luma reconstruction block according to an embodiment of the disclosure.

When the inter-coding mode is applied to the current block, the encoder and decoder may configure a first luma reference block (RefA in (a) of FIG. 24) indicated by motion information of the current block as a first luma reconstruction block, and may derive a CCP model by using a first luma reconstruction block and a second luma reference block (RefB in (a) of FIG. 24) indicated by the motion information of the first luma reconstruction block. The encoder and decoder may generate a luma prediction block of the current block by applying the derived linear and non-linear models to the first luma reference block (RefA in (a) of FIG. 24). The encoder and decoder may generate a weight-averaged luma prediction block of the current block by weighted averaging between the luma prediction block of the current block and the first luma reference block (RefA in (a) of FIG. 24).

When the current block is applied with an inter-coding mode and is predicted through bidirectional motion, the encoder and decoder may derive a CCP model by using a first luma reference block indicated by L0 motion information of the current block and a second luma reference block indicated by L1 motion information of the current block. The encoder and decoder may apply the derived CCP model to the first luma reference block and the second luma reference block, respectively, to generate the first and second luma prediction blocks of the current block. The encoder and decoder may generate a weight-averaged luma prediction block of the current block by weighted averaging between the first and second luma prediction blocks of the current block and the first and second luma reference blocks. The above-mentioned prediction block generation method of the luma block may also be applied to chroma components. The encoder and decoder may derive a CCP model for each chroma component and apply the CCP model to chroma block prediction.

When the current block is applied with an inter-coding mode and is predicted through bidirectional motion, the encoder and decoder may derive a CCP model by using the neighboring block (A in (b) of FIG. 24) adjacent to the current block and the luma prediction block for the A block (RefA0, RefA1 in (b) of FIG. 24). The encoder and decoder may apply the derived CCP model to the luma prediction blocks (Ref0, Ref1) of the current block to generate the first and second luma prediction blocks of the current block. The encoder and decoder may generate a weight-averaged luma prediction block of the current block by using weighted averaging between the first and second luma prediction blocks of the current block and the prediction blocks (Ref0, Ref1) of the current block. When the inter-coding mode is applied to the current block and is predicted through bidirectional motion, the previously described method of generating a prediction block for the luma block may be applied to the chroma component. In addition, the encoder and decoder may derive a CCP model for each chroma component and apply chroma block prediction.

The above methods described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented by hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1. A decoding apparatus for decoding a video signal,
the decoding apparatus comprising a processor,
wherein the processor is configured to:
acquire a model that models a relationship between a value of a luma sample of a current block and a value of a chroma sample of the current block, based on a value of at least one sample from among a neighboring luma sample of the current block, a chroma sample corresponding to the neighboring luma sample of the current block, a neighboring luma sample of a reference block, and a chroma sample corresponding to the neighboring luma sample of the reference block; and
predict a chroma block of the current block by using the acquired model and a luma block of the current block.

2. The decoding apparatus of claim 1, wherein the processor is configured to:
generate a chroma prediction block by using the acquired model and the luma block of the current block; and
reconstruct the chroma block of the current block by adding an error block to the chroma prediction block.

3. The decoding apparatus of claim 1, wherein the processor is configured to:
when the decoding apparatus acquires the model, acquire a first model and a second model;
generate a first chroma prediction sample by using the luma sample of the current block and the first model;
generate a second chroma prediction sample by using the luma sample of the current block and the second model;
generate a third chroma prediction sample by performing weighted averaging of the first chroma prediction sample and the second chroma prediction sample;
generate a chroma prediction block by using the third chroma prediction sample; and
reconstruct the chroma block of the current block by adding the error block to the chroma prediction block.

4. The decoding apparatus of claim 3, wherein the processor is configured to, in case that the current block is coded in an inter-coding mode and is applied with bi-directional prediction, derive the first model by using a first prediction block predicted using L0 motion information and derive the second model by using a second prediction block predicted using L1 motion information.

5. The decoding apparatus of claim 2, wherein an input value input to the model comprises a value obtained by subtracting a predesignated first offset value from the value of the luma sample of the current block, a value obtained by subtracting a predesignated second offset value from the value of a Cb chroma sample of the current block, and a value obtained by subtracting a predesignated third offset value from the value of a Cr chroma sample of the current block.

6. The decoding apparatus of claim 5,
wherein the predesignated first offset value is a value of a luma sample at a predesignated position among the neighboring samples of the current block,
the predesignated second offset value is a value of a Cb chroma sample at the predesignated position, and
the predesignated third offset value is a value of a Cr chroma sample at the predesignated position.

7. The decoding apparatus of claim 6, wherein in case that the value of the luma sample at the predesignated position does not fall within a predesignated range, the processor is configured to use a predesignated basic first offset value as the first offset value, a predesignated basic second offset value as the second offset value, and a predesignated basic third offset value as the third offset value.

8. The decoding apparatus of claim 6, wherein in case that the value of the luma sample at the predesignated position does not fall within a predesignated range, the processor is configured to determine that the chroma block of the current block is unable to use an coding mode based on the model, and omit to parse at least one syntax element related to the model.

9. The decoding apparatus of claim 6, wherein in case that the value of the luma sample at the predesignated position does not fall within a predesignated range, the processor is configured to determine in a predesignated order whether values of luma samples at a plurality of predesignated positions are valid as the first offset value, and in case that a luma sample value valid as the first offset value is discovered, the processor is configured to use the discovered luma sample value as the first offset value, the value of the Cb chroma sample corresponding to the discovered luma sample value as the second offset value, and the value of the Cr chroma sample corresponding to the discovered luma sample as the third offset value.

10. The decoding apparatus of claim 6, wherein the processor is configured to parse offset sample information indicating an offset sample from a bitstream including the video signal, and use the value of the luma sample indicated by the offset sample information as the first offset value, use the value of the Cb chroma sample indicated by the offset sample information as the second offset value, and use the value of the Cr chroma sample indicated by the offset sample information as the third offset value.

11-18. (canceled)

19. An encoding apparatus for encoding a video signal,
the encoding apparatus comprising a processor,
wherein the processor is configured to:
acquire a model that models the relationship between the value of the luma sample of the current block and the value of the chroma sample of the current block, based on a value of at least one sample from among a neighboring luma sample of a current block, a chroma sample corresponding to the neighboring luma sample of the current block, a neighboring luma sample of a reference block, and a chroma sample corresponding to the neighboring luma sample of the reference block; and
predict the chroma block of the current block by using the acquired model and the luma block of the current block.

20. (canceled)

21. A decoding method for decoding a video signal, the decoding method comprising:
acquiring a model that models the relationship between a value of a luma sample of a current block and a value of a chroma sample of the current block, based on a value of at least one sample from among a neighboring luma sample of the current block, a chroma sample corresponding to the neighboring luma sample of the current block, a neighboring luma sample of a reference block, and a chroma sample corresponding to the neighboring luma sample of the reference block; and
predicting a chroma block of the current block by using the acquired model and a luma block of the current block.

22. (canceled)

23. A non-transitory computer-readable storage medium storing a bitstream,
wherein the bitstream is decoded using a decoding method, and
wherein the decoding method comprises:
acquiring a model that models the relationship between the value of the luma sample of the current block and the value of the chroma sample of the current block, based on a value of at least one sample from among a neighboring luma sample of a current block, a chroma sample corresponding to the neighboring luma sample of the current block, a neighboring luma sample of a reference block, and a chroma sample corresponding to the neighboring luma sample of the reference block; and
predicting the chroma block of the current block by using the acquired model and the luma block of the current block.

24. (canceled)
